(19) United States
(12) Patent Application Publication
(10) Pub. No.: US 2024/0094507 A1
(43) Pub. Date: Mar. 21, 2024

(54) OPTICAL IMAGING SYSTEM

(71) Applicant: SAMSUNG ELECTRO-MECHANICS CO., LTD., Suwon-si (KR)

(72) Inventors: Ji Su LEE, Suwon-si (KR); Dong Hyuk JANG, Suwon-si (KR)

(73) Assignee: SAMSUNG ELECTRO-MECHANICS CO., LTD., Suwon-si (KR)

(21) Appl. No.: 18/448,772

(22) Filed: Aug. 11, 2023

(30) Foreign Application Priority Data
Sep. 14, 2022 (KR) 10-2022-0115736

(51) Int. Cl. G02B 9/64; G02B 13/18

(52) U.S. Cl. CPC G02B 9/64; G02B 13/18

(57) ABSTRACT

An optical imaging system includes a first lens having positive refractive power, a convex object-side surface and a concave image-side surface; a second lens having negative refractive power, a convex object-side surface and a concave image-side surface; a third lens having positive refractive power; a fourth lens having negative refractive power; a fifth lens; a sixth lens having a convex object-side surface; and a seventh lens having negative refractive power, a convex object-side surface and a concave image-side surface, wherein the first to seventh lenses are disposed in order from an object side toward an imaging plane, wherein the optical imaging system has a total of seven lenses, and wherein 0<f1/f<1.5, −5<f2/f<−1, −10<f3/f/100<2, −5<f4/f/100<1, −0.5<f1/f2<0, −1<f1/f3<3, 70°<FOV×(IMG HT/f), and |f1/f4/n4|<0.3 are satisfied.

### CROSS-REFERENCE TO RELATED APPLICATIONS

This application claims the benefit under 35 USC 119(a) of Korean Patent Application No. 10-2022-0115736 filed on Sep. 14, 2022, in the Korean Intellectual Property Office, the entire disclosure of which is incorporated herein by reference for all purposes.

### BACKGROUND

### 1. Field

The present disclosure relates to an optical imaging system.

### 2. Description of the Background

A portable terminal may include a camera provided with an optical imaging system including a plurality of lenses to perform video calls and to take pictures.

Functions of cameras in portable terminals may include high resolution.

An image sensor having a high pixel count (e.g., 13 million to 100 million pixels) may be employed in a camera for a portable terminal to implement clearer image quality.

Since a portable terminal may be designed to have a small size and a camera for portable terminals may also have a reduced size, development of an optical imaging system having a slim size and implementing high resolution may be an objective.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having positive refractive power, a convex object-side surface and a concave image-side surface; a second lens having negative refractive power, a convex object-side surface and a concave image-side surface; a third lens having positive refractive power; a fourth lens having negative refractive power; a fifth lens having refractive power; a sixth lens having refractive power and a convex object-side surface; and a seventh lens having negative refractive power, a convex object-side surface and a concave image-side surface, wherein the first to seventh lenses are disposed in order from an object side of the optical imaging system toward an imaging plane of the optical imaging system, wherein the optical imaging system has a total of seven lenses, and wherein 0<f1/f<1.5, −5<f2/f<−1, −10<f3/f/100<2, −5<f4/f/100<1, −0.5<f1/f2<0, −1<f1/f3<3, 70°<FOV×(IMG HT/f), and |f1/f4/n4|<0.3 are satisfied, where f is a total focal length of the optical imaging system, f1 is a focal length of the first lens, f2 is a focal length of the second lens, f3 is a focal length of the third lens, f4 is a focal length of the fourth lens, FOV is a field of view of the optical imaging system, IMG HT is half a diagonal length of the imaging plane, and n4 is a refractive index of the fourth lens.

25<v1−v2<45 and 25<v1−v4<45 may be satisfied, where v1 is an Abbe number of the first lens, v2 is an Abbe number of the second lens, and v4 is an Abbe number of the fourth lens.

v2+v4<v1, and v2+v4<v3 may be satisfied, where v3 is an Abbe number of the third lens.

|f1/f2/n2|<0.3 may be satisfied, where n2 is a refractive index of the second lens.

−3<f5/f/100<3 may be satisfied, where f5 is a focal length of the fifth lens.

−50<f6/f<10 may be satisfied, where f6 is a focal length of the sixth lens.

−5<f7/f<0 may be satisfied, where f7 is a focal length of the seventh lens.

D1/f<0.1 may be satisfied, where D1 is a distance on an optical axis between the image-side surface of the first lens and the object-side surface of the second lens.

TTL/f<1.3 and BFL/f<0.3 may be satisfied, where BFL is a distance on an optical axis from the image-side surface of the seventh lens to the imaging plane, and TTL is a distance on the optical axis from the object-side surface of the first lens to the imaging plane.

1.5<f/EPD<2.3 may be satisfied, where EPD is an incident pupil diameter of the optical imaging system.

2<CT1/ET1<5 may be satisfied, where CT1 is a thickness of the first lens on an optical axis, and ET1 is a thickness of the first lens at an end of an effective diameter.

At least one of SWA71<30° and SWA72<42° may be satisfied, where SWA71 is a sweep angle of the seventh lens on an end of an effective diameter of the object-side surface of the seventh lens, and SWA72 is a sweep angle of the seventh lens on an end of an effective diameter of the image-side surface of the seventh lens.

The first to seventh lenses may be formed of a plastic material, and an object-side surface and an image-side surface of each of the first to seventh lenses may be aspherical.

The sixth lens may have at least one inflection point formed on at least one of the object-side surface and an image-side surface.

The seventh lens may have at least one inflection point formed on at least one of the object-side surface and the image-side surface.

The third lens may have a convex object-side surface.

The fourth lens may have a concave object-side surface and a concave image-side surface.

The fifth lens may have a convex image-side surface.

The sixth lens may have a concave image-side surface.

The fifth lens may have positive refractive power, and the sixth lens may have negative refractive power.

Other features and aspects will be apparent from the following detailed description, the drawings, and the claims.

### BRIEF DESCRIPTION OF DRAWINGS

FIG. 1 is a diagram illustrating an optical imaging system according to a first embodiment of the present disclosure.

FIG. 2 shows curves indicating aberration properties of the optical imaging system illustrated in FIG. 1.

FIG. 3 is a diagram illustrating an optical imaging system according to a second embodiment of the present disclosure.

FIG. 4 shows curves indicating aberration properties of the optical imaging system illustrated in FIG. 3.

FIG. 5 is a diagram illustrating an optical imaging system according to a third embodiment of the present disclosure.

FIG. 6 shows curves indicating aberration properties of the optical imaging system illustrated in FIG. 5.

FIG. 7 is a diagram illustrating an optical imaging system according to a fourth embodiment of the present disclosure.

FIG. 8 shows curves indicating aberration properties of the optical imaging system illustrated in FIG. 7.

FIG. 9 is a diagram illustrating an optical imaging system according to a fifth embodiment of the present disclosure.

FIG. 10 shows curves indicating aberration properties of the optical imaging system illustrated in FIG. 9.

FIG. 11 is a diagram illustrating an optical imaging system according to a sixth embodiment of the present disclosure.

FIG. 12 shows curves indicating aberration properties of the optical imaging system illustrated in FIG. 11.

FIG. 13 is diagram illustrating an optical imaging system according to a seventh embodiment of the present disclosure.

FIG. 14 shows curves indicating aberration properties of the optical imaging system illustrated in FIG. 13.

FIG. 15 is a diagram illustrating a diagram illustrating an optical imaging system according to an eighth embodiment of the present disclosure.

FIG. 16 shows curves indicating aberration properties of the optical imaging system illustrated in FIG. 15.

FIG. 17 is a diagram illustrating an optical imaging system according to a ninth embodiment of the present disclosure.

FIG. 18 shows curves indicating aberration properties of the optical imaging system illustrated in FIG. 17.

FIG. 19 is a diagram illustrating an optical imaging system according to a tenth embodiment of the present disclosure.

FIG. 20 shows curves indicating aberration properties of the optical imaging system illustrated in FIG. 19.

FIG. 21 is a diagram illustrating an optical imaging system according to an eleventh embodiment of the present disclosure.

FIG. 22 shows curves indicating aberration properties of the optical imaging system illustrated in FIG. 21.

FIG. 23 is a diagram illustrating a sweep angle in a specific position on a lens surface.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide an optical imaging system which may implement high resolution and may have a reduced total length.

In the diagrams illustrating the lenses, a thickness, a size, and a shape of the lens are exaggerated to illustrate an example, and a spherical or an aspherical shape of the lens illustrated in the diagram is an example, and a shape is not limited thereto.

The first lens refers to the lens most adjacent to an object side, and the seventh lens refers to the lens most adjacent to an imaging plane (or an image sensor).

Also, in each lens, the first surface refers to a surface adjacent to an object side (or an object-side surface), and the second surface refers to a surface adjacent to an image side (or an image-side surface). Also, in embodiments, units of numerical values for a radius of curvature, thickness, distance, focal length, or the like of the lens are millimeters, and a unit of a field of view (FOV) is degrees.

Also, in the descriptions of the shape of each lens, the notion in which one surface is convex indicates that a paraxial region of the surface is convex, the notion in which one surface is concave indicates that a paraxial region of the surface is concave, and the notion that one surface is planar indicates that a paraxial region of the surface is planar. Therefore, even when it is described that one surface of the lens is convex, an edge portion of the lens may be concave. Similarly, even when it is described that one surface of the lens is concave, an edge portion of the lens may be convex. Also, when it is described that one surface of the lens is planar, an edge portion of the lens may be convex or concave.

The paraxial region refers to a relatively narrow region neighboring to and including an optical axis.

The imaging plane may refer to a virtual plane on which a focus may be formed by an optical imaging system. Alternatively, the imaging plane may refer to one surface of the image sensor on which light is incident or the inside of the image sensor on which light is incident.

The optical imaging system in an embodiment may include seven lenses.

For example, the optical system in an embodiment may include a first lens, a second lens, a third lens, a fourth lens, a fifth lens, a sixth lens, and a seventh lens disposed in order from an object side. The first to seventh lenses may be spaced apart from each other by a predetermined distance along the optical axis. For example, the optical system in an embodiment may include no more than seven lenses.

However, the optical imaging system in an embodiment may not simply include seven lenses, and may further include other components for a predetermined objective.

For example, the optical imaging system may further include an image sensor for converting an incident image of a subject into an electrical signal.

Also, the optical imaging system may further include an infrared filter (hereinafter, referred to as a “filter”) for blocking infrared rays. The filter may be disposed between the seventh lens and the image sensor.

Also, the optical imaging system may further include a stop for adjusting the amount of light.

The first to seventh lenses included in the optical imaging system in an embodiment may be formed of a plastic material.

Also, at least one of the first to seventh lenses has an aspherical surface. Also, each of the first to seventh lenses may have at least one aspherical surface.

That is, at least one of the first and second surfaces of the first to seventh lenses may be aspherical. Here, the aspherical surfaces of the first to seventh lenses are represented by Equation 1.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad [ Equation 1 ]$$

In Equation 1, c is a radius of curvature of the lens (a reciprocal of a radius of curvature), K is a conic constant, and Y is a distance from one point on the aspherical surface of the lens to the optical axis. Also, constants A to H, J, and L to P refer to aspheric coefficients. Z is a distance between one point on the aspherical surface of the lens and an apex of the aspherical surface in an optical axis direction.

The optical imaging system in an embodiment may satisfy at least one of conditional expressions as below:

0<f1/f<1.5 [Conditional Expression 1]

25<v1−v2<45 [Conditional Expression 2]

25<v1−v4<45 [Conditional Expression 3]

0≤v1−v6<25 [Conditional Expression 4]

−5<f2/f<−1 [Conditional Expression 5]

−10<f3/f/100<2 [Conditional Expression 6]

−5<f4/f/100<1 [Conditional Expression 7]

−3<f5/f/100<3 [Conditional Expression 8]

−50<f6/f<10 [Conditional Expression 9]

−5<f7/f<0 [Conditional Expression 10]

TTL/f<1.3 [Conditional Expression 11]

−0.5<f1/f2<0 [Conditional Expression 12]

−1<f1/f3<3 [Conditional Expression 13]

BFL/f<0.3 [Conditional Expression 14]

D1/f<0.1 [Conditional Expression 15]

TTL/(2×IMG HT)<0.62 [Conditional Expression 16]

70°<FOV×(IMG HT/f)[Conditional Expression 17]

1.5<f/EPD<2.3 [Conditional Expression 18]

2<CT1/ET1<5 [Conditional Expression 19]

|f1/f2/n2|<0.3 [Conditional Expression 20]

|f1/f4/n4|<0.3 [Conditional Expression 21]

SWA71<30° [Conditional Expression 22]

SWA72<42° [Conditional Expression 23]

v2+v4<v3 [Conditional Expression 24]

v2+v4<v1 [Conditional Expression 25]

4.9<n2+n4+n5<5.2 [Conditional Expression 26]

In the conditional expressions, f is a total focal length of the optical imaging system, f1 is the focal length of the first lens, f2 is the focal length of the second lens, f3 is the focal length of the third lens, f4 is the focal length of the fourth lens, f5 is the focal length of the fifth lens, f6 is the focal length of the sixth lens, and f7 is the focal length of the seventh lens.

v1 is the Abbe number of the first lens, v2 is the Abbe number of the second lens, v3 is the Abbe number of the third lens, v4 is the Abbe number of the fourth lens, and v6 is the Abbe number of the sixth lens.

TTL is a distance from the object-side surface of the first lens to an imaging plane on an optical axis, and BFL is the distance from the image-side surface of the seventh lens to the imaging plane on the optical axis.

D1 is an optical axis distance between the image-side surface of the first lens and the object side surface of the second lens, IMG HT is half the diagonal length of the imaging surface, EPD is the incident pupil diameter, and FOV is the field of view of the optical imaging system.

n2 is the refractive index of the second lens, and n4 is the refractive index of the fourth lens.

CT1 is the thickness of the first lens on the optical axis, and ET1 is the thickness of the first lens on the optical axis on the end of the effective diameter.

SWA71 is a sweep angle of the seventh lens on the end of an effective diameter of the object-side surface, and SWA72 is a sweep angle of the seventh lens on an end of the effective diameter of the image-side surface.

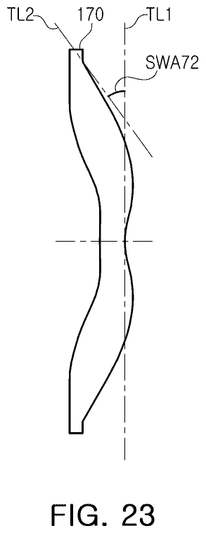

FIG. 23 illustrates a sweep angle at a specific position on the lens surface. For example, a sweep angle at a specific position of the image-side surface of the seventh lens may be defined as an angle between the tangent line TL1 at an apex of the image-side surface and the tangent line TL2 at the specific position. The apex of the image-side surface may be a point at which the image-side surface meets the optical axis.

First to seventh lenses included in the optical imaging system in one or more embodiments will be described.

The first lens may have positive refractive power. Also, the first lens may have a meniscus shape convex toward the object. In greater detail, the first surface of the first lens may be convex, and the second surface of the first lens may be concave.

At least one of the first surface and the second surface of the first lens may be aspherical. For example, both surfaces of the first lens may be aspherical.

The second lens may have negative refractive power. Also, the second lens may have a meniscus shape convex toward the object side. In greater detail, the first surface of the second lens may be convex, and the second surface of the second lens may be concave.

At least one of the first surface and the second surface of the second lens may be aspherical. For example, both surfaces of the second lens may be aspherical.

The third lens may have positive refractive power. Also, the third lens may have a meniscus shape convex toward the object. In greater detail, the first surface of the third lens may be convex and the second surface of the third lens may be concave.

Alternatively, the third lens may have a meniscus shape convex toward the image side. In greater detail, the first surface of the third lens may be concave, and the second surface of the third lens may be convex.

At least one of the first surface and the second surface of the third lens may be aspherical. For example, both surfaces of the third lens may be aspherical.

The fourth lens may have negative refractive power. Also, the fourth lens may have a meniscus shape convex toward the object side. In greater detail, the first surface of the fourth lens may be convex, and the second surface of the fourth lens may be concave.

Alternatively, the fourth lens may have a meniscus shape convex toward the image side. In greater detail, the first surface of the fourth lens may be concave, and the second surface of the fourth lens may be convex.

Alternatively, both surfaces of the fourth lens may be concave. In greater detail, the first surface and the second surface of the fourth lens may be concave. When both surfaces of the fourth lens are concave, the fourth lens may have negative refractive power.

At least one of the first surface and the second surface of the fourth lens may be aspherical. For example, both surfaces of the fourth lens may be aspherical.

The fifth lens may have negative refractive power. Also, the fifth lens may have a meniscus shape convex toward the object. In greater detail, the first surface of the fifth lens may be convex, and a second surface of the fifth lens may be concave.

Alternatively, both surfaces of the fifth lens may be convex. In greater detail, the first surface and the second surface of the fifth lens may be convex.

Alternatively, both surfaces of the fifth lens may be concave. In greater detail, the first surface and the second surface of the fifth lens may be concave.

At least one of the first surface and the second surface of the fifth lens may be aspherical. For example, both surfaces of the fifth lens may be aspherical.

The sixth lens may have positive refractive power or negative refractive power. Also, the sixth lens may have a meniscus shape convex toward the object side. In greater detail, the first surface of the sixth lens may be convex in the paraxial region, and the second surface of the sixth lens may be concave in the paraxial region.

Alternatively, both surfaces of the sixth lens may be convex. In greater detail, the first surface and the second surface of the sixth lens may be convex.

At least one of the first surface and the second surface of the sixth lens may be aspherical. For example, both surfaces of the sixth lens may be aspherical.

The sixth lens may have at least one inflection point formed on at least one of the first surface and the second surface. For example, the first surface of the sixth lens may be convex in the paraxial region and may be concave in a portion other than the paraxial region. The second surface of the sixth lens may be convex in the paraxial region and may be concave in a portion other than the paraxial region.

The seventh lens may have negative refractive power. Also, the seventh lens may have a meniscus shape convex toward the object side. In greater detail, the first surface of the seventh lens may be convex in the paraxial region, and the second surface of the seventh lens may be concave in the paraxial region.

At least one of the first surface and the second surface of the seventh lens may be aspherical. For example, both surfaces of the seventh lens may be aspherical.

Also, at least one inflection point may be formed on at least one of the first surface and the second surface of the seventh lens. For example, the first surface of the seventh lens may be convex in the paraxial region and may be concave in a portion other than the paraxial region. The second surface of the seventh lens may be concave in the paraxial region and may be convex in a portion other than the paraxial region.

Each of the first to seventh lenses may be formed of a plastic material having optical properties different from those of adjacent lenses. For example, refractive indices and Abbe numbers of the lenses adjacent to each other may be different.

In an embodiment, the refractive index of the second lens, the fourth lens, and the fifth lens may be 1.61 or more.

At least two lenses among the first to seventh lenses may have a refractive index of 1.67 or more. In an embodiment, the refractive index of the second lens and the fourth lens may be 1.67 or more.

In an embodiment, a lens having a negative refractive power among the first to fourth lenses may have a refractive index of 1.67 or more. For example, the second lens and the fourth lens may have negative refractive power and a refractive index of 1.67 or more.

In an embodiment, each of the second lens and the fourth lens may have higher refractive indices and lower Abbe numbers than those of adjacent lenses.

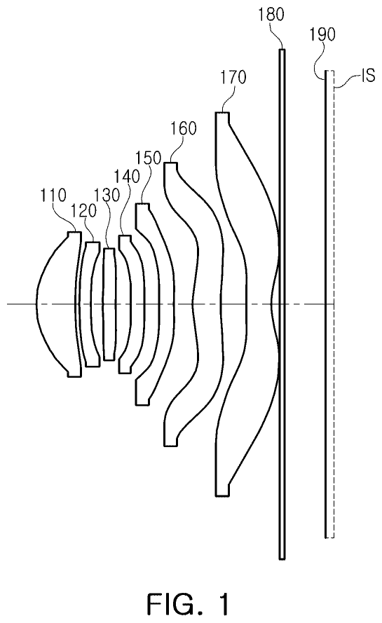

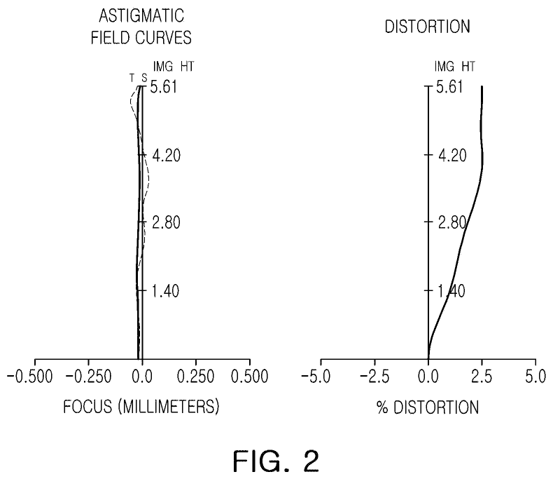

An optical imaging system according to a first embodiment will be described with reference to FIGS. 1 and 2.

The optical imaging system in the first embodiment may include an optical system including a first lens 110, a second lens 120, a third lens 130, a fourth lens 140, a fifth lens 150, a sixth lens 160, and a seventh lens 170, and may further include a filter 180 and an image sensor IS.

The optical imaging system 100 in the first embodiment may form a focus on the imaging plane 190. The imaging plane 190 may refer to a surface on which a focus may be formed by the optical imaging system. For example, the imaging plane 190 may refer to one surface of the image sensor IS on which light is incident.

The lens characteristics of each lens (a radius of curvature, a thickness of the lens or a distance between the lenses, a refractive index, an Abbe number, and a focal length) are listed in Table 1.

TABLE 1

| Surface | | Radius of | Thickness or | Refractive | Abbe | Focal |
|---|---|---|---|---|---|---|
| No. | Elements | curvature | distance | index | number | length |
| S1 | First lens | 2.241 | 0.920 | 1.544 | 56.0 | 5.43 |
| S2 | | 7.836 | 0.104 | | | |
| S3 | Second lens | 7.939 | 0.250 | 1.671 | 19.2 | −16.41 |
| S4 | | 4.577 | 0.299 | | | |
| S5 | Third lens | 13.121 | 0.313 | 1.544 | 56.0 | 26.07 |
| S6 | | 165.332 | 0.351 | | | |
| S7 | Fourth lens | −20.985 | 0.314 | 1.671 | 19.2 | −24.75 |
| S8 | | 84.895 | 0.358 | | | |
| S9 | Fifth lens | 50.607 | 0.349 | 1.614 | 25.9 | −67.75 |
| S10 | | 22.893 | 0.459 | | | |
| S11 | Sixth lens | 3.608 | 0.671 | 1.567 | 37.4 | 8.88 |
| S12 | | 11.680 | 0.594 | | | |
| S13 | Seventh lens | 5.104 | 0.601 | 1.535 | 55.7 | −6.28 |
| S14 | | 1.947 | 0.206 | | | |
| S15 | Filter | Infinity | 0.110 | 1.517 | 64.2 | |
| S16 | | Infinity | 0.991 | | | |
| S17 | Imaging plane | Infinity | | | | |

The total focal length f of the optical imaging system in the first embodiment may be 6.08 mm, IMG HT may be 5.605 mm, FOV may be 83.8°, Fno may be 1.95, ET1 may be 0.301 mm, SWA71 may be 23.88°, and SWA72 may be 30°.

In the first embodiment, the first lens 110 may have positive refractive power, the first surface of the first lens 110 may be convex, and the second surface of the first lens 110 may be concave.

The second lens 120 may have negative refractive power, a first surface of the second lens 120 may be convex, and a second surface of the second lens 120 may be concave.

The third lens 130 may have positive refractive power, a first surface of the third lens 130 may be convex, and a second surface of the third lens 130 may be concave.

The fourth lens 140 may have negative refractive power, the first and second surfaces of the fourth lens 140 may be concave.

The fifth lens 150 may have negative refractive power, the first surface of the fifth lens 150 may be convex, and the second surface of the fifth lens 150 may be concave.

The sixth lens 160 may have positive refractive power, and the first surface of the sixth lens 160 may be convex in the paraxial region, and the second surface of the sixth lens 160 may be concave in the paraxial region.

Also, at least one inflection point may be formed on at least one of the first and second surfaces of the sixth lens 160. For example, the first surface of the sixth lens 160 may be convex in the paraxial region and may be concave in a portion other than the paraxial region. Also, the second surface of the sixth lens 160 may be concave in the paraxial region and may be convex in a portion other than the paraxial region.

The seventh lens 170 may have negative refractive power, the first surface of the seventh lens 170 may be convex in the paraxial region, and the second surface of the seventh lens 170 may be concave in the paraxial region.

Also, at least one inflection point may be formed on at least one of the first and second surfaces of the seventh lens 170. For example, the first surface of the seventh lens 170 may be convex in the paraxial region and may be concave in a portion other than the paraxial region. Also, the second surface of the seventh lens 170 may be concave in the paraxial region and may be convex in a portion other than the paraxial region.

Each surface of the first lens 110 to the seventh lens 170 may have an aspherical coefficient as in Table 2. For example, both the object-side surface and the image-side surface of the first lens 110 to the seventh lens 170 may be aspherical.

TABLE 2

| | S1 | S2 | S3 | S4 | S5 | S6 | S7 |
|---|---|---|---|---|---|---|---|
| Conic | 2.241 | 7.836 | 7.939 | 4.577 | 13.121 | 165.332 | −20.985 |
| constant (K) | | | | | | | |
| 4th order | 6.9135E−03 | −1.2056E−02 | −2.2992E−02 | −2.8306E−02 | −3.0231E−02 | −1.1891E−02 | −5.7724E−02 |
| coefficient(A) | | | | | | | |
| 6th order | −2.0019E−02 | 1.2036E−03 | −5.1455E−02 | 1.3041E−01 | 1.0545E−01 | −1.3678E−01 | −3.6770E−02 |
| coefficient(B) | | | | | | | |
| 8th order | 1.4321E−01 | −2.3396E−02 | 4.0929E−01 | −9.0117E−01 | −8.4522E−01 | 9.4182E−01 | 2.0665E−01 |
| coefficient(C) | | | | | | | |
| 10th order | −5.0962E−01 | 2.7169E−01 | −1.3370E+00 | 4.3825E+00 | 4.3687E+00 | −4.2402E+00 | −1.5232E−02 |
| coefficient(D) | | | | | | | |
| 12th order | 1.1418E+00 | −9.9207E−01 | 2.8070E+00 | −1.4047E+01 | −1.5186E+01 | 1.2945E+01 | −3.4142E+00 |
| coefficient(E) | | | | | | | |
| 14th order | −1.7298E+00 | 2.0704E+00 | −4.0018E+00 | 3.1200E+01 | 3.6797E+01 | −2.7598E+01 | 1.4699E+01 |
| coefficient(F) | | | | | | | |
| 16th order | 1.8370E+00 | −2.8368E+00 | 3.9111E+00 | −4.9657E+01 | −6.3479E+01 | 4.1952E+01 | −3.3117E+01 |
| coefficient(G) | | | | | | | |
| 18th order | −1.3923E+00 | 2.6880E+00 | −2.5725E+00 | 5.7586E+01 | 7.8798E+01 | −4.5986E+01 | 4.7390E+01 |
| coefficient(H) | | | | | | | |
| 20th order | 7.5674E−01 | −1.7954E+00 | 1.0614E+00 | −4.8802E+01 | −7.0441E+01 | 3.6401E+01 | −4.5693E+01 |
| coefficient(J) | | | | | | | |
| 22nd order | −2.9256E−01 | 8.4445E−01 | −2.0703E−01 | 2.9909E+01 | 4.4886E+01 | −2.0596E+01 | 3.0153E+01 |
| coefficient(L) | | | | | | | |
| 24th order | 7.8501E−02 | −2.7391E−01 | −2.7687E−02 | −1.2902E+01 | −1.9869E+01 | 8.1168E+00 | −1.3454E+01 |
| coefficient(M) | | | | | | | |
| 26th order | −1.3891E−02 | 5.8344E−02 | 2.6887E−02 | 3.7130E+00 | 5.8024E+00 | −2.1148E+00 | 3.8849E+00 |
| coefficient(N) | | | | | | | |
| 28th order | 1.4572E−03 | −7.3460E−03 | −6.2009E−03 | −6.3948E−01 | −1.0046E+00 | 3.2725E−01 | −6.5552E−01 |
| coefficient(O) | | | | | | | |
| 30th order | −6.9000E−05 | 4.1433E−04 | 5.2182E−04 | 4.9814E−02 | 7.8066E−02 | −2.2766E−02 | 4.9091E−02 |
| coefficient(P) | | | | | | | |
| | S8 | S9 | S10 | S11 | S12 | S13 | S14 |
| Conic | 84.895 | 50.607 | 22.893 | 3.608 | 11.680 | 5.104 | 1.947 |
| constant (K) | | | | | | | |
| 4th order | −8.2033E−02 | −1.0480E−01 | −1.1596E−01 | 6.4591E−04 | 1.0341E−02 | −1.3820E−01 | −6.9193E−02 |
| coefficient(A) | | | | | | | |
| 6th order | 2.1342E−01 | 1.3386E−01 | 2.6692E−02 | −2.2507E−02 | −4.3494E−03 | 6.4559E−02 | 2.6375E−02 |
| coefficient(B) | | | | | | | |
| 8th order | −9.8933E−01 | −3.4968E−01 | 7.9248E−02 | 4.4627E−03 | −1.2542E−02 | −2.8891E−02 | −8.7621E−03 |
| coefficient(C) | | | | | | | |
| 10th order | 3.2944E+00 | 9.3525E−01 | −1.7116E−01 | 6.7150E−03 | 1.2822E−02 | 1.1338E−02 | 2.2853E−03 |
| coefficient(D) | | | | | | | |
| 12th order | −7.6088E+00 | −1.7852E+00 | 1.9863E−01 | −8.1713E−03 | −6.6463E−03 | −3.1858E−03 | −4.3074E−04 |
| coefficient(E) | | | | | | | |
| 14th order | 1.2283E+01 | 2.3592E+00 | −1.5211E−01 | 4.9024E−03 | 2.2363E−03 | 6.2107E−04 | 5.7000E−05 |
| coefficient(F) | | | | | | | |
| 16th order | −1.4099E+01 | −2.2030E+00 | 8.0250E−02 | −1.9179E−03 | −5.2386E−04 | −8.6000E−05 | −5.0000E−06 |
| coefficient(G) | | | | | | | |
| 18th order | 1.1636E+01 | 1.4741E+00 | −2.9585E−02 | 5.1776E−04 | 8.8000E−05 | 8.0000E−06 | 2.6520E−07 |
| coefficient(H) | | | | | | | |
| 20th order | −6.9154E+00 | −7.0889E−01 | 7.6310E−03 | −9.7000E−05 | −1.1000E−05 | −1.0000E−06 | −4.7436E−09 |
| coefficient(J) | | | | | | | |
| 22nd order | 2.9303E+00 | 2.4274E−01 | −1.3615E−03 | 1.3000E−05 | 1.0000E−06 | 3.1537E−08 | −4.1447E−10 |
| coefficient(L) | | | | | | | |
| 24th order | −8.6246E−01 | −5.7693E−02 | 1.6321E−04 | −1.0000E−06 | −5.6211E−08 | −1.1444E−09 | 3.6505E−11 |
| coefficient(M) | | | | | | | |
| 26th order | 1.6733E−01 | 9.0351E−03 | −1.2000E−05 | 6.3179E−08 | 2.3126E−09 | 2.7692E−11 | −1.3467E−12 |
| coefficient(N) | | | | | | | |
| 28th order | −1.9211E−02 | −8.3733E−04 | 1.0000E−06 | −2.0902E−09 | −5.7949E−11 | −4.0139E−13 | 2.5449E−14 |
| coefficient(O) | | | | | | | |
| 30th order | 9.8711E−04 | 3.5000E−05 | −9.2316E−09 | 3.0623E−11 | 6.7267E−13 | 2.6366E−15 | −2.0109E−16 |
| coefficient(P) | | | | | | | |

Also, the optical imaging system configured as described above may have the aberration characteristics illustrated in FIG. 2.

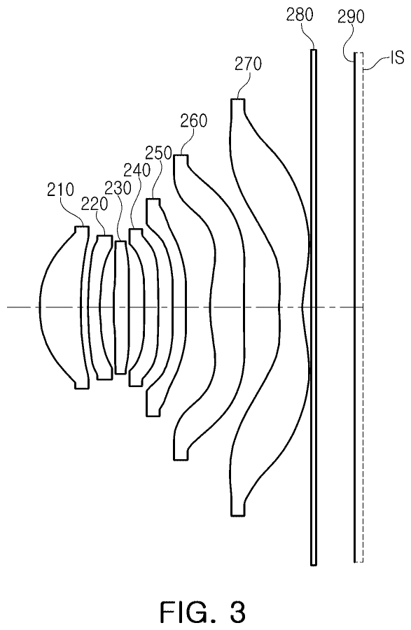

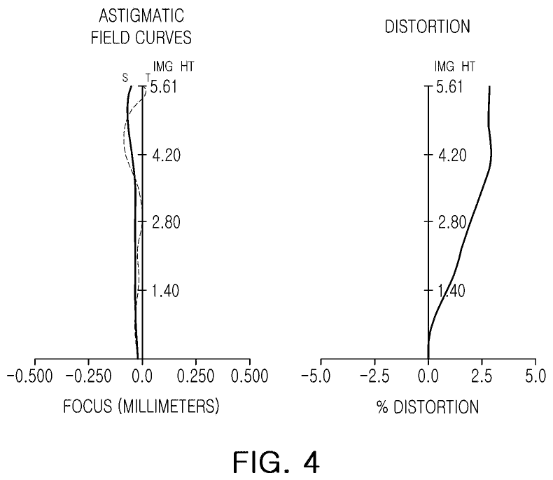

An optical imaging system according to a second embodiment will be described with reference to FIGS. 3 and 4.

The optical imaging system in the second embodiment may include an optical system including a first lens 210, a second lens 220, a third lens 230, a fourth lens 240, a fifth lens 250, a sixth lens 260, and a seventh lens 270, and may further include a filter 280 and an image sensor IS.

The optical imaging system in the second embodiment may form a focus on the imaging plane 290. The imaging plane 290 may refer to a surface on which a focus may be formed by the optical imaging system. For example, the imaging plane 290 may refer to one surface of the image sensor IS on which light is received.

The lens characteristics of each lens (a radius of curvature, a thickness of the lens or a distance between the lenses, a refractive index, an Abbe number, and a focal length) are listed in Table 3.

TABLE 3

| Surface | | Radius of | Thickness or | Refractive | Abbe | Focal |
|---|---|---|---|---|---|---|
| No. | Elements | curvature | distance | index | number | length |
| S1 | First lens | 2.263 | 0.906 | 1.544 | 56.0 | 5.58 |
| S2 | | 7.530 | 0.157 | | | |
| S3 | Second lens | 9.386 | 0.260 | 1.680 | 18.2 | −16.32 |
| S4 | | 5.059 | 0.307 | | | |
| S5 | Third lens | 9.684 | 0.322 | 1.535 | 55.7 | 25.55 |
| S6 | | 32.520 | 0.342 | | | |
| S7 | Fourth lens | −32.883 | 0.303 | 1.680 | 18.2 | −28.25 |
| S8 | | 47.904 | 0.313 | | | |
| S9 | Fifth lens | 35.016 | 0.301 | 1.614 | 25.9 | −92.89 |
| S10 | | 21.705 | 0.538 | | | |
| S11 | Sixth lens | 4.467 | 0.732 | 1.567 | 37.4 | 7.68 |
| S12 | | −215.631 | 0.767 | | | |
| S13 | Seventh lens | 7.162 | 0.487 | 1.535 | 55.7 | −4.94 |
| S14 | | 1.891 | 0.206 | | | |
| S15 | Filter | Infinity | 0.110 | 1.517 | 64.2 | |
| S16 | | Infinity | 0.840 | | | |
| S17 | Imaging plane | Infinity | | | | |

The total focal length f of the optical imaging system in the second embodiment may be 6.08 mm, IMG HT may be 5.605 mm, FOV may be 83.61°, Fno may be 1.795, ET1 may be 0.289 mm, SWA71 may be 29.67°, and SWA72 may be 41.66°.

In the second embodiment, the first lens 210 may have positive refractive power, the first surface of the first lens 210 may be convex, and the second surface of the first lens 210 may be concave.

The second lens 220 may have negative refractive power, a first surface of the second lens 220 may be convex, and a second surface of the second lens 220 may be concave.

The third lens 230 may have positive refractive power, a first surface of the third lens 230 may be convex, and a second surface of the third lens 230 may be concave.

The fourth lens 240 may have negative refractive power, the first and second surfaces of the fourth lens 240 may be concave.

The fifth lens 250 may have negative refractive power, the first surface of the fifth lens 250 may be convex, and the second surface of the fifth lens 250 may be concave.

The sixth lens 260 may have positive refractive power, and the first and second surfaces of the sixth lens 260 may be convex in the paraxial region.

Also, at least one inflection point may be formed on at least one of the first and second surfaces of the sixth lens 260. For example, the first surface of the sixth lens 260 may be convex in the paraxial region and may be concave in a portion other than the paraxial region. Also, the second surface of the sixth lens 260 may be convex in the paraxial region and may be concave in a portion other than the paraxial region.

The seventh lens 270 may have negative refractive power, the first surface of the seventh lens 270 may be convex in the paraxial region, and the second surface of the seventh lens 270 may be concave in the paraxial region.

Also, at least one inflection point may be formed on at least one of the first and second surfaces of the seventh lens 270. For example, the first surface of the seventh lens 270 may be convex in the paraxial region and may be concave in a portion other than the paraxial region. Also, the second surface of the seventh lens 270 may be concave in the paraxial region and may be convex in a portion other than the paraxial region.

Each surface of the first lens 210 to the seventh lens 270 may have an aspherical coefficient as in Table 4. For example, both the object-side surface and the image-side surface of the first lens 210 to the seventh lens 270 may be aspherical.

TABLE 4

| | S1 | S2 | S3 | S4 | S5 | S6 | S7 |
|---|---|---|---|---|---|---|---|
| Conic | −0.532 | −2.133 | 14.908 | 4.712 | −4.827 | −42.562 | 98.917 |
| constant (K) | | | | | | | |
| 4th order | 8.2677E−03 | −9.8944E−03 | −1.9642E−02 | −7.5263E−03 | −4.4374E−02 | −9.4683E−03 | −2.9234E−02 |
| coefficient(A) | | | | | | | |
| 6th order | −1.7487E−02 | 3.6469E−02 | 3.0179E−02 | −8.5178E−02 | 2.4029E−01 | −1.2257E−01 | −1.9319E−01 |
| coefficient(B) | | | | | | | |
| 8th order | 6.1270E−02 | −1.7338E−01 | −2.8844E−02 | 7.0796E−01 | −1.3672E+00 | 5.5051E−01 | 1.3409E+00 |
| coefficient(C) | | | | | | | |
| 10th order | −8.3774E−02 | 5.8226E−01 | −4.2569E−02 | −2.9021E+00 | 4.8277E+00 | −1.3378E+00 | −5.9825E+00 |
| coefficient(D) | | | | | | | |
| 12th order | −1.5535E−02 | −1.2969E+00 | 3.2548E−01 | 7.5540E+00 | −1.1219E+01 | 1.1539E+00 | 1.7764E+01 |
| coefficient(E) | | | | | | | |
| 14th order | 2.3071E−01 | 1.9733E+00 | −8.3595E−01 | −1.3196E+01 | 1.7619E+01 | 2.5402E+00 | −3.6682E+01 |
| coefficient(F) | | | | | | | |
| 16th order | −3.8871E−01 | −2.1045E+00 | 1.2938E+00 | 1.5820E+01 | −1.8740E+01 | −9.8160E+00 | 5.3962E+01 |
| coefficient(G) | | | | | | | |
| 18th order | 3.6291E−01 | 1.5977E+00 | −1.3415E+00 | −1.3010E+01 | 1.3059E+01 | 1.5826E+01 | −5.7230E+01 |
| coefficient(H) | | | | | | | |
| 20th order | −2.1911E−01 | −8.6742E−01 | 9.6325E−01 | 7.1239E+00 | −5.2439E+00 | −1.5623E+01 | 4.3826E+01 |
| coefficient(J) | | | | | | | |
| 22nd order | 8.9120E−02 | 3.3420E−01 | −4.8071E−01 | −2.3679E+00 | 4.5751E−01 | 1.0187E+01 | −2.3990E+01 |
| coefficient(L) | | | | | | | |
| 24th order | −2.4360E−02 | −8.9210E−02 | 1.6365E−01 | 3.2441E−01 | 6.9122E−01 | −4.4216E+00 | 9.1483E+00 |
| coefficient(M) | | | | | | | |
| 26th order | 4.3013E−03 | 1.5687E−02 | −3.6241E−02 | 6.3373E−02 | −3.8244E−01 | 1.2330E+00 | −2.3076E+00 |
| coefficient(N) | | | | | | | |
| 28th order | −4.4408E−04 | −1.6343E−03 | 4.7041E−03 | −3.1223E−02 | 8.7383E−02 | −2.0030E−01 | 3.4599E−01 |
| coefficient(O) | | | | | | | |
| 30th order | 2.0000E−05 | 7.6000E−05 | −2.7149E−04 | 3.5694E−03 | −7.8637E−03 | 1.4425E−02 | −2.3343E−02 |
| coefficient(P) | | | | | | | |
| | S8 | S9 | S10 | S11 | S12 | S13 | S14 |
| Conic | −91.102 | −7.544 | 33.949 | −21.417 | −91.075 | −7.261 | −9.415 |
| constant (K) | | | | | | | |
| 4th order | −5.4941E−02 | −1.0815E−01 | −1.2585E−01 | −1.0826E−02 | −9.8351E−03 | −1.9715E−01 | −8.0093E−02 |
| coefficient(A) | | | | | | | |
| 6th order | 8.0025E−02 | 2.7770E−02 | 2.7112E−02 | −9.6986E−03 | 2.0348E−02 | 1.2737E−01 | 4.2526E−02 |
| coefficient(B) | | | | | | | |
| 8th order | −3.2848E−01 | 2.4939E−01 | 1.4553E−01 | 1.2392E−02 | −2.4079E−02 | −6.4703E−02 | −1.7424E−02 |
| coefficient(C) | | | | | | | |
| 10th order | 1.0526E+00 | −8.0526E−01 | −3.5584E−01 | −1.6152E−02 | 1.4424E−02 | 2.3692E−02 | 5.0470E−03 |
| coefficient(D) | | | | | | | |
| 12th order | −2.4048E+00 | 1.4118E+00 | 4.6145E−01 | 1.2348E−02 | −5.8471E−03 | −6.0071E−03 | −1.0323E−03 |
| coefficient(E) | | | | | | | |
| 14th order | 3.8152E+00 | −1.6395E+00 | −3.8808E−01 | −5.9370E−03 | 1.7665E−03 | 1.0698E−03 | 1.5181E−04 |
| coefficient(F) | | | | | | | |
| 16th order | −4.2542E+00 | 1.3334E+00 | 2.2414E−01 | 1.9130E−03 | −4.1107E−04 | −1.3663E−04 | −1.6000E−05 |
| coefficient(G) | | | | | | | |
| 18th order | 3.3725E+00 | −7.7788E−01 | −9.1095E−02 | −4.3323E−04 | 7.4000E−05 | 1.3000E−05 | 1.0000E−06 |
| coefficient(H) | | | | | | | |
| 20th order | −1.9058E+00 | 3.2772E−01 | 2.6262E−02 | 7.1000E−05 | −1.0000E−05 | −1.0000E−06 | −7.3268E−08 |
| coefficient(J) | | | | | | | |
| 22nd order | 7.6060E−01 | −9.8902E−02 | −5.3382E−03 | −9.0000E−06 | 1.0000E−06 | 4.2054E−08 | 3.0192E−09 |
| coefficient(L) | | | | | | | |
| 24th order | −2.0898E−01 | 2.0843E−02 | 7.4782E−04 | 1.0000E−06 | −7.1184E−08 | −1.4493E−09 | −8.6590E−11 |
| coefficient(M) | | | | | | | |
| 26th order | 3.7511E−02 | −2.9115E−03 | −6.9000E−05 | −4.3158E−08 | 3.4311E−09 | 3.3382E−11 | 1.6254E−12 |
| coefficient(N) | | | | | | | |
| 28th order | −3.9472E−03 | 2.4221E−04 | 4.0000E−06 | 1.5231E−09 | −9.9680E−11 | −4.6144E−13 | −1.7665E−14 |
| coefficient(O) | | | | | | | |
| 30th order | 1.8394E−04 | −9.0000E−06 | −9.0414E−08 | −2.4357E−11 | 1.3136E−12 | 2.8953E−15 | 8.1764E−17 |
| coefficient(P) | | | | | | | |

Also, the optical imaging system configured as described above may have the aberration characteristics illustrated in FIG. 4.

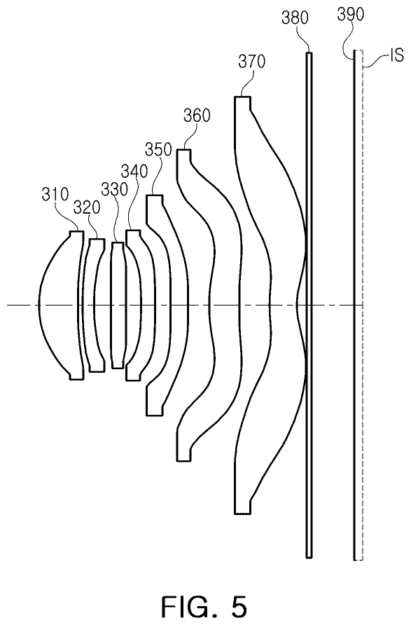

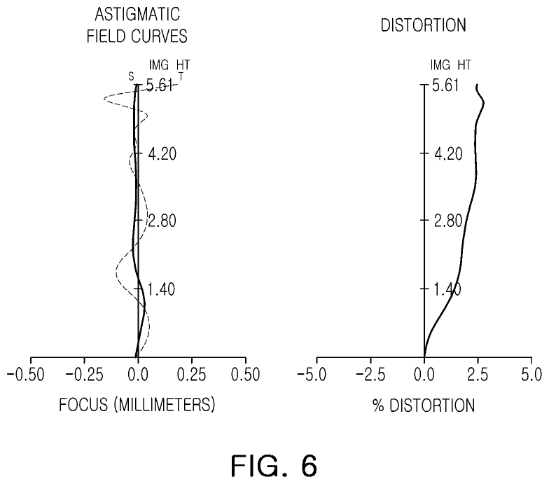

An optical imaging system according to a third embodiment will be described with reference to FIGS. 5 and 6.

The optical imaging system in the third embodiment may include an optical system including a first lens 310, a second lens 320, a third lens 330, a fourth lens 340, a fifth lens 350, a sixth lens 360, and a seventh lens 370, and may further include a filter 380 and an image sensor IS.

The optical imaging system in the third embodiment may form a focus on the imaging plane 390. The imaging plane 390 may refer to a surface on which a focus may be formed by the optical imaging system. For example, the imaging plane 390 may refer to one surface of the image sensor IS on which light is incident.

The lens characteristics of each lens (a radius of curvature, a thickness of the lens or a distance between the lenses, a refractive index, an Abbe number, and a focal length) are listed in Table 5.

TABLE 5

| Surface | | Radius of | Thickness or | Refractive | Abbe | Focal |
|---|---|---|---|---|---|---|
| No. | Elements | curvature | distance | index | number | length |
| S1 | First lens | 2.226 | 0.848 | 1.544 | 56.0 | 5.4 |
| S2 | | 7.849 | 0.100 | | | |
| S3 | Second lens | 6.987 | 0.250 | 1.671 | 19.2 | −17.19 |
| S4 | | 4.307 | 0.366 | | | |
| S5 | Third lens | 15.208 | 0.335 | 1.544 | 56.0 | 29.13 |
| S6 | | 338.913 | 0.314 | | | |
| S7 | Fourth lens | −16.674 | 0.313 | 1.671 | 19.2 | −19 |
| S8 | | 57.361 | 0.341 | | | |
| S9 | Fifth lens | 22.585 | 0.378 | 1.614 | 25.9 | 145.05 |
| S10 | | 29.966 | 0.474 | | | |
| S11 | Sixth lens | 3.863 | 0.655 | 1.567 | 37.4 | 9.72 |
| S12 | | 11.946 | 0.669 | | | |
| S13 | Seventh lens | 5.017 | 0.591 | 1.535 | 55.7 | −6.08 |
| S14 | | 1.897 | 0.206 | | | |
| S15 | Filter | Infinity | 0.110 | 1.517 | 64.2 | |
| S16 | | Infinity | 0.947 | | | |
| S17 | Imaging plane | Infinity | | | | |

The total focal length f of the optical imaging system in the third embodiment may be 6.09 mm, IMG HT may be 5.605 mm, FOV may be 83.8°, Fno may be 1.946, ET1 may be 0.299 mm, SWA71 may be 24.74°, and SWA72 may be 31.3°.

In the third embodiment, the first lens 310 may have positive refractive power, the first surface of the first lens 310 may be convex, and the second surface of the first lens 310 may be concave.

The second lens 320 may have negative refractive power, a first surface of the second lens 320 may be convex, and a second surface of the second lens 320 may be concave.

The third lens 330 may have positive refractive power, a first surface of the third lens 330 may be convex, and a second surface of the third lens 330 may be concave.

The fourth lens 340 may have negative refractive power, the first and second surfaces of the fourth lens 340 may be concave.

The fifth lens 350 may have positive refractive power, the first surface of the fifth lens 350 may be convex, and the second surface of the fifth lens 350 may be concave.

The sixth lens 360 may have positive refractive power, and the first surface of the sixth lens 360 may be convex in the paraxial region, and the second surface of the sixth lens 360 may be concave in the paraxial region.

Also, at least one inflection point may be formed on at least one of the first and second surfaces of the sixth lens 360. For example, the first surface of the sixth lens 360 may be convex in the paraxial region and may be concave in a portion other than the paraxial region. Also, the second surface of the sixth lens 360 may be concave in the paraxial region and may be convex in a portion other than the paraxial region.

The seventh lens 370 may have negative refractive power, the first surface of the seventh lens 370 may be convex in the paraxial region, and the second surface of the seventh lens 370 may be concave in the paraxial region.

Also, at least one inflection point may be formed on at least one of the first and second surfaces of the seventh lens 370. For example, the first surface of the seventh lens 370 may be convex in the paraxial region and may be concave in a portion other than the paraxial region. Also, the second surface of the seventh lens 370 may be concave in the paraxial region and may be convex in a portion other than the paraxial region.

Each surface of the first lens 310 to the seventh lens 370 may have an aspherical coefficient as in Table 6. For example, both the object-side surface and the image-side surface of the first lens 310 to the seventh lens 370 may be aspherical.

TABLE 6

| | S1 | S2 | S3 | S4 | S5 | S6 | S7 |
|---|---|---|---|---|---|---|---|
| Conic | −0.597 | −9.919 | 3.119 | 2.141 | 27.392 | 99.000 | |
| constant (K) | | | | | | | |
| 4th order | 6.2968E−03 | −4.9129E−02 | −2.7541E−02 | −2.8423E−02 | −4.7222E−02 | −7.5700E−03 | −71.993 |
| coefficient(A) | | | | | | | |
| 6th order | 1.6244E−02 | 3.2043E−01 | −5.0483E−02 | 1.1262E−01 | 2.5394E−01 | −2.9137E−01 | −1.0784E−02 |
| coefficient(B) | | | | | | | |
| 8th order | −1.0178E−01 | −1.6389E+00 | 5.6478E−01 | −8.4766E−01 | −1.2055E+00 | 2.3912E+00 | −5.7155E−01 |
| coefficient(C) | | | | | | | |
| 10th order | 3.7865E−01 | 5.5824E+00 | −2.4392E+00 | 4.8027E+00 | 2.8109E+00 | −1.1358E+01 | 3.6379E+00 |
| coefficient(D) | | | | | | | |
| 12th order | −9.0299E−01 | −1.2901E+01 | 6.8968E+00 | −1.7834E+01 | −1.1151E+00 | 3.4951E+01 | −1.4606E+01 |
| coefficient(E) | | | | | | | |
| 14th order | 1.4730E+00 | 2.0923E+01 | −1.3643E+01 | 4.5156E+01 | −1.2125E+01 | −7.3961E+01 | 3.9900E+01 |
| coefficient(F) | | | | | | | |
| 16th order | −1.6995E+00 | −2.4378E+01 | 1.9344E+01 | −8.0471E+01 | 3.8762E+01 | 1.1126E+02 | −7.7319E+01 |
| coefficient(G) | | | | | | | |
| 18th order | 1.4094E+00 | 2.0653E+01 | −1.9854E+01 | 1.0269E+02 | −6.3536E+01 | −1.2096E+02 | 1.0873E+02 |
| coefficient(H) | | | | | | | |
| 20th order | −8.4322E−01 | −1.2739E+01 | 1.4749E+01 | −9.4283E+01 | 6.6445E+01 | 9.5402E+01 | −1.1215E+02 |
| coefficient(J) | | | | | | | |
| 22nd order | 3.6062E−01 | 5.6603E+00 | −7.8404E+00 | 6.1754E+01 | −4.6686E+01 | −5.4087E+01 | 8.4875E+01 |
| coefficient(L) | | | | | | | |
| 24th order | −1.0748E−01 | −1.7648E+00 | 2.9037E+00 | −2.8147E+01 | 2.2045E+01 | 2.1484E+01 | −4.6597E+01 |
| coefficient(M) | | | | | | | |
| 26th order | 2.1198E−02 | 3.6631E−01 | −7.1081E−01 | 8.4807E+00 | −6.7305E+00 | −5.6756E+00 | 1.8063E+01 |
| coefficient(N) | | | | | | | |
| 28th order | −2.4857E−03 | −4.5456E−02 | 1.0329E−01 | −1.5180E+00 | 1.2028E+00 | 8.9569E−01 | −4.6879E+00 |
| coefficient(O) | | | | | | | |
| 30th order | 1.3115E−04 | 2.5513E−03 | −6.7410E−03 | 1.2220E−01 | −9.5676E−02 | −6.3892E−02 | 7.3108E−01 |
| coefficient(P) | | | | | | | |
| | S8 | S9 | S10 | S11 | S12 | S13 | −5.1798E−02 |
| Conic | −99.000 | −99.000 | 88.340 | −15.104 | −93.862 | −18.311 | S14 |
| constant (K) | | | | | | | |
| 4th order | −3.0675E−02 | −1.5757E−01 | −1.1176E−01 | −6.8863E−03 | −3.6691E−03 | −1.5168E−01 | −7.041 |
| coefficient(A) | | | | | | | |
| 6th order | −3.0966E−01 | 5.2751E−01 | 8.1727E−02 | 3.3093E−03 | 3.6196E−02 | 9.5006E−02 | −8.0873E−02 |
| coefficient(B) | | | | | | | |
| 8th order | 1.7408E+00 | −1.8632E+00 | −1.1307E−01 | −3.4027E−02 | −6.5134E−02 | −5.3515E−02 | 4.4852E−02 |
| coefficient(C) | | | | | | | |
| 10th order | −5.6999E+00 | 4.5143E+00 | 1.6107E−01 | 3.9186E−02 | 5.3612E−02 | 2.2267E−02 | −2.2076E−02 |
| coefficient(D) | | | | | | | |
| 12th order | 1.2377E+01 | −7.4732E+00 | −1.6437E−01 | −2.5733E−02 | −2.7826E−02 | −6.2815E−03 | 8.1072E−03 |
| coefficient(E) | | | | | | | |
| 14th order | −1.8794E+01 | 8.7152E+00 | 1.1902E−01 | 1.1452E−02 | 1.0002E−02 | 1.2213E−03 | −2.1559E−03 |
| coefficient(F) | | | | | | | |
| 16th order | 2.0496E+01 | −7.3193E+00 | −6.2984E−02 | −3.6763E−03 | −2.5856E−03 | −1.6814E−04 | 4.1858E−04 |
| coefficient(G) | | | | | | | |
| 18th order | −1.6264E+01 | 4.4733E+00 | 2.4735E−02 | 8.6553E−04 | 4.8772E−04 | 1.7000E−05 | −6.0000E−05 |
| coefficient(H) | | | | | | | |
| 20th order | 9.4053E+00 | −1.9891E+00 | −7.1873E−03 | −1.4833E−04 | −6.7000E−05 | −1.0000E−06 | 6.0000E−06 |
| coefficient(J) | | | | | | | |
| 22nd order | −3.9239E+00 | 6.3603E−01 | 1.5178E−03 | 1.8000E−05 | 7.0000E−06 | 6.1829E−08 | −4.8383E−07 |
| coefficient(L) | | | | | | | |
| 24th order | 1.1506E+00 | −1.4229E−01 | −2.2529E−04 | −2.0000E−06 | −4.6399E−07 | −2.2358E−09 | 2.6855E−08 |
| coefficient(M) | | | | | | | |
| 26th order | −2.2507E−01 | 2.1112E−02 | 2.2000E−05 | 8.5147E−08 | 2.1469E−08 | 5.3816E−11 | −1.0438E−09 |
| coefficient(N) | | | | | | | |
| 28th order | 2.6377E−02 | −1.8643E−03 | −1.0000E−06 | −2.7799E−09 | −5.9242E−10 | −7.7497E−13 | 2.6912E−11 |
| coefficient(O) | | | | | | | |
| 30th order | −1.4014E−03 | 7.4000E−05 | 3.4031E−08 | 4.0482E−11 | 7.3718E−12 | 5.0548E−15 | −4.1282E−13 |
| coefficient(P) | | | | | | | |
| | | | | | | | 2.8488E−15 |

Also, the optical imaging system configured as described above may have the aberration characteristics illustrated in FIG. 6.

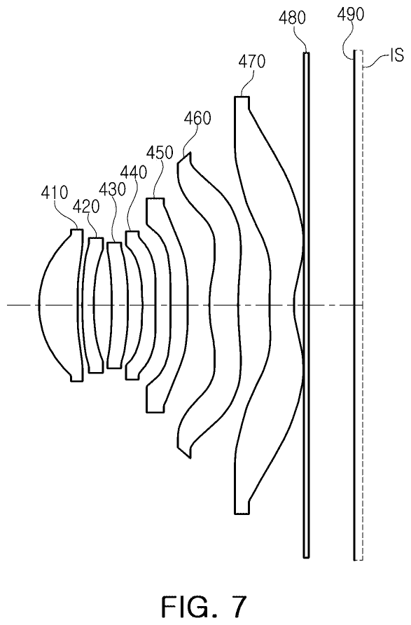

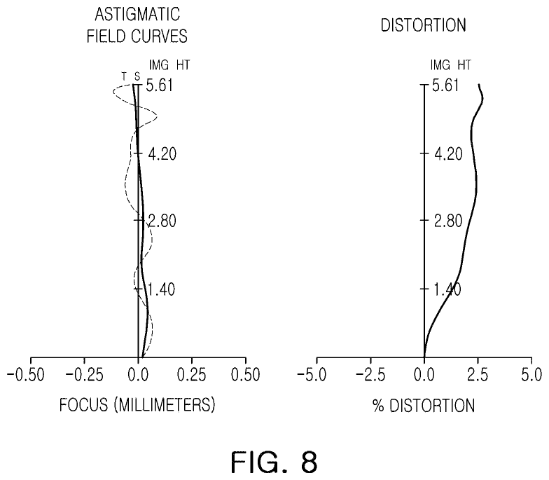

An optical imaging system according to a fourth embodiment will be described with reference to FIGS. 7 and 8.

The optical imaging system in the fourth embodiment may include an optical system including a first lens 410, a second lens 420, a third lens 430, a fourth lens 440, a fifth lens 450, a sixth lens 460, and a seventh lens 470, and may further include a filter 480 and an image sensor IS.

The optical imaging system in the fourth embodiment may form a focus on the imaging plane 490. The imaging plane 490 may refer to a surface on which a focus may be formed by the optical imaging system. For example, the imaging plane 490 may refer to one surface of the image sensor IS on which light is incident.

The lens characteristics of each lens (a radius of curvature, a thickness of the lens or a distance between the lenses, a refractive index, an Abbe number, and a focal length) are listed in Table 7.

TABLE 7

| Surface | | Radius of | Thickness or | Refractive | Abbe | Focal |
|---|---|---|---|---|---|---|
| No. | Elements | curvature | distance | index | number | length |
| S1 | First lens | 2.220 | 0.854 | 1.544 | 56.0 | 5.22 |
| S2 | | 8.684 | 0.100 | | | |
| S3 | Second lens | 8.088 | 0.250 | 1.671 | 19.2 | −18.83 |
| S4 | | 4.892 | 0.378 | | | |
| S5 | Third lens | −29.597 | 0.361 | 1.544 | 56.0 | 32.55 |
| S6 | | −11.156 | 0.314 | | | |
| S7 | Fourth lens | −7.563 | 0.294 | 1.671 | 19.2 | −15.85 |
| S8 | | −25.846 | 0.324 | | | |
| S9 | Fifth lens | 23.408 | 0.374 | 1.614 | 25.9 | 158.09 |
| S10 | | 30.563 | 0.481 | | | |
| S11 | Sixth lens | 3.727 | 0.631 | 1.567 | 37.4 | 9.49 |
| S12 | | 11.226 | 0.678 | | | |
| S13 | Seventh lens | 4.678 | 0.540 | 1.535 | 55.7 | −6.49 |
| S14 | | 1.917 | 0.206 | | | |
| S15 | Filter | Infinity | 0.110 | 1.517 | 64.2 | |
| S16 | | Infinity | 0.995 | | | |
| S17 | Imaging plane | Infinity | | | | |

The total focal length f of the optical imaging system in the fourth embodiment may be 6.11 mm, IMG HT may be 5.605 mm, FOV may be 83.8°, Fno may be 1.945, ET1 may be 0.255 mm, SWA71 may be 26.64°, and SWA72 may be 32.75°.

In the fourth embodiment, the first lens 410 may have positive refractive power, the first surface of the first lens 410 may be convex, and the second surface of the first lens 410 may be concave.

The second lens 420 may have negative refractive power, a first surface of the second lens 420 may be convex, and a second surface of the second lens 420 may be concave.

The third lens 430 may have positive refractive power, a first surface of the third lens 430 may be concave, and a second surface of the third lens 430 may be convex.

The fourth lens 440 may have negative refractive power, the first surface of the fourth lens 440 may be concave, and the second surface of the fourth lens 440 may be convex.

The fifth lens 450 may have positive refractive power, the first surface of the fifth lens 450 may be convex, and the second surface of the fifth lens 450 may be concave.

The sixth lens 460 may have positive refractive power, the first surface of the sixth lens 460 may be convex in the paraxial region, and the second surface of the sixth lens 460 may be concave in the paraxial region.

Also, at least one inflection point may be formed on at least one of the first and second surfaces of the sixth lens 460. For example, the first surface of the sixth lens 460 may be convex in the paraxial region and may be concave in a portion other than the paraxial region. Also, the second surface of the sixth lens 460 may be concave in the paraxial region and may be convex in a portion other than the paraxial region.

The seventh lens 470 may have negative refractive power, the first surface of the seventh lens 470 may be convex in the paraxial region, and the second surface of the seventh lens 470 may be concave in the paraxial region.

Also, at least one inflection point may be formed on at least one of the first and second surfaces of the seventh lens 470. For example, the first surface of the seventh lens 470 may be convex in the paraxial region and may be concave in a portion other than the paraxial region. Also, the second surface of the seventh lens 470 may be concave in the paraxial region and may be convex in a portion other than the paraxial region.

Each surface of the first lens 410 to the seventh lens 470 may have an aspherical coefficient as in Table 8. For example, both the object-side surface and the image-side surface of the first lens 410 to the seventh lens 470 may be aspherical.

TABLE 8

| | S1 | S2 | S3 | S4 | S5 | S6 | S7 |
|---|---|---|---|---|---|---|---|
| Conic | −0.569 | −12.023 | 2.826 | 2.416 | 99.000 | −31.204 | −62.271 |
| constant (K) | | | | | | | |
| 4th order | −1.0458E−02 | −2.1823E−02 | −2.9452E−02 | −3.0096E−02 | −7.4068E−03 | 3.5897E−02 | 4.6598E−02 |
| coefficient(A) | | | | | | | |
| 6th order | 1.6756E−01 | 4.7603E−02 | 1.1458E−02 | 2.8618E−02 | −2.5390E−01 | −1.0475E+00 | −1.3557E+00 |
| coefficient(B) | | | | | | | |
| 8th order | −8.7629E−01 | −1.4657E−01 | −3.8372E−02 | 7.9485E−01 | 1.9978E+00 | 8.7742E+00 | 8.9511E+00 |
| coefficient(C) | | | | | | | |
| 10th order | 2.8401E+00 | 4.2475E−01 | 7.8972E−01 | −7.6990E+00 | −1.0221E+01 | −4.4792E+01 | −3.7487E+01 |
| coefficient(D) | | | | | | | |
| 12th order | −6.0739E+00 | −9.4728E−01 | −4.0827E+00 | 3.6601E+01 | 3.5906E+01 | 1.5053E+02 | 1.0702E+02 |
| coefficient(E) | | | | | | | |
| 14th order | 8.9672E+00 | 1.5848E+00 | 1.1516E+01 | −1.0783E+02 | −8.9468E+01 | −3.4847E+02 | −2.1638E+02 |
| coefficient(F) | | | | | | | |
| 16th order | −9.3953E+00 | −1.9709E+00 | −2.0777E+01 | 2.1306E+02 | 1.6132E+02 | 5.7124E+02 | 3.1650E+02 |
| coefficient(G) | | | | | | | |
| 18th order | 7.0873E+00 | 1.8049E+00 | 2.5453E+01 | −2.9263E+02 | −2.1233E+02 | −6.7284E+02 | −3.3819E+02 |
| coefficient(H) | | | | | | | |
| 20th order | −3.8601E+00 | −1.2035E+00 | −2.1675E+01 | 2.8335E+02 | 2.0370E+02 | 5.7119E+02 | 2.6381E+02 |
| coefficient(J) | | | | | | | |
| 22nd order | 1.5037E+00 | 5.7430E−01 | 1.2856E+01 | −1.9288E+02 | −1.4060E+02 | −3.4628E+02 | −1.4848E+02 |
| coefficient(L) | | | | | | | |
| 24th order | −4.0833E−01 | −1.9041E−01 | −5.2127E+00 | 9.0367E+01 | 6.7877E+01 | 1.4617E+02 | 5.8667E+01 |
| coefficient(M) | | | | | | | |
| 26th order | 7.3391E−02 | 4.1551E−02 | 1.3783E+00 | −2.7752E+01 | −2.1718E+01 | −4.0800E+01 | −1.5434E+01 |
| coefficient(N) | | | | | | | |
| 28th order | −7.8431E−03 | −5.3561E−03 | −2.1419E−01 | 5.0302E+00 | 4.1322E+00 | 6.7666E+00 | 2.4265E+00 |
| coefficient(O) | | | | | | | |
| 30th order | 3.7716E−04 | 3.0850E−04 | 1.4843E−02 | −4.0796E−01 | −3.5354E−01 | −5.0476E−01 | −1.7245E−01 |
| coefficient(P) | | | | | | | |

| | S8 | S9 | S10 | S11 | S12 | S13 | S14 |
|---|---|---|---|---|---|---|---|
| Conic | −99.000 | −60.118 | 87.491 | −15.152 | −96.641 | −18.832 | −6.891 |
| constant (K) | | | | | | | |
| 4th order | −3.0606E−02 | −1.1377E−01 | −1.1135E−01 | −6.7269E−03 | −4.0659E−04 | −1.4661E−01 | −7.8413E−02 |
| coefficient(A) | | | | | | | |
| 6th order | −3.0327E−01 | 1.6349E−01 | 7.5625E−02 | 1−7.6178E−04 | 2.4319E−02 | 8.8829E−02 | 4.1468E−02 |
| coefficient(B) | | | | | | | |
| 8th order | 1.7689E+00 | −3.1485E−01 | −8.4561E−02 | −2.0205E−02 | −4.6005E−02 | −4.9532E−02 | −1.9966E−02 |
| coefficient(C) | | | | | | | |
| 10th order | −5.9864E+00 | 5.1759E−01 | 1.1148E−01 | 2.1086E−02 | 3.6285E−02 | 2.0725E−02 | 7.2677E−03 |
| coefficient(D) | | | | | | | |
| 12th order | 1.3458E+01 | −6.5222E−01 | −1.1703E−01 | −1.2135E−02 | −1.7931E−02 | −5.9128E−03 | −1.9118E−03 |
| coefficient(E) | | | | | | | |
| 14th order | −2.1213E+01 | 6.3555E−01 | 9.2338E−02 | 4.8287E−03 | 6.1970E−03 | 1.1674E−03 | 3.6609E−04 |
| coefficient(F) | | | | | | | |
| 16th order | 2.4072E+01 | −4.8806E−01 | −5.4726E−02 | −1.4580E−03 | −1.5634E−03 | −1.6391E−04 | −5.2000E−05 |
| coefficient(G) | | | | | | | |
| 18th order | −1.9913E+01 | 2.9296E−01 | 2.4066E−02 | 3.3977E−04 | 2.9207E−04 | 1.7000E−05 | 5.0000E−06 |
| coefficient(H) | | | | | | | |
| 20th order | 1.2020E+01 | −1.3378E−01 | −7.6932E−03 | −5.9000E−05 | −4.0000E−05 | −1.0000E−06 | −4.0985E−07 |
| coefficient(J) | | | | | | | |
| 22nd order | −5.2357E+00 | 4.4847E−02 | 1.7456E−03 | 7.0000E−06 | 4.0000E−06 | 6.5457E−08 | 2.2674E−08 |
| coefficient(L) | | | | | | | |
| 24th order | 1.6023E+00 | −1.0557E−02 | −2.7224E−04 | −1.0000E−06 | −2.8786E−07 | −2.4488E−09 | −8.8146E−10 |
| coefficient(M) | | | | | | | |
| 26th order | −3.2677E−01 | 1.6354E−03 | 2.8000E−05 | 3.6497E−08 | 1.3651E−08 | 6.1123E−11 | 2.2791E−11 |
| coefficient(N) | | | | | | | |
| 28th order | 3.9865E−02 | −1.4838E−04 | −2.0000E−06 | −1.2047E−09 | −3.8735E−10 | −9.1433E−13 | −3.5129E−13 |
| coefficient(O) | | | | | | | |
| 30th order | −2.2004E−03 | 6.0000E−06 | 4.3409E−08 | 1.7631E−11 | 4.9658E−12 | 6.2017E−15 | 2.4388E−15 |
| coefficient(P) | | | | | | | |

Also, the optical imaging system configured as described above may have the aberration characteristics illustrated in FIG. 8.

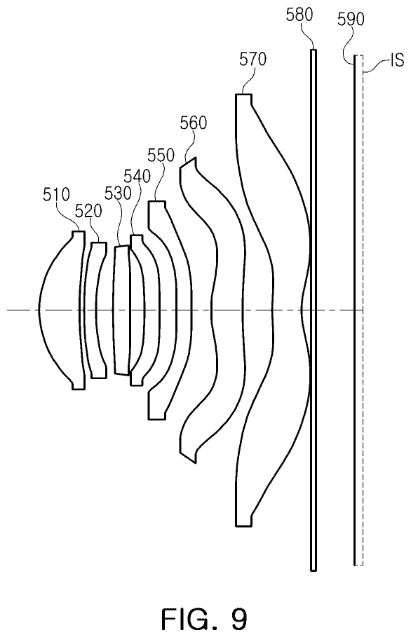

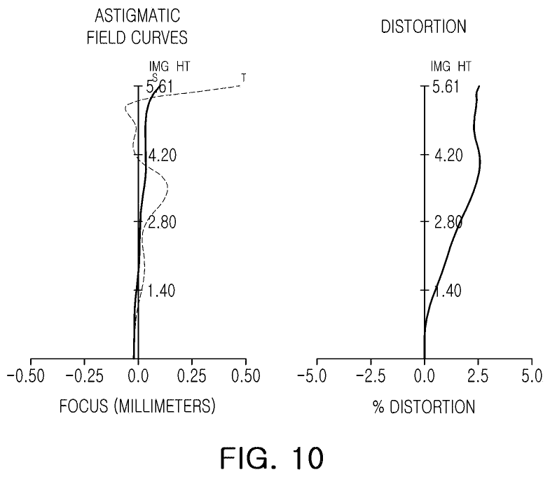

An optical imaging system according to a fifth embodiment will be described with reference to FIGS. 9 and 10.

The optical imaging system in the fifth embodiment may include an optical system including a first lens 510, a second lens 520, a third lens 530, a fourth lens 540, a fifth lens 550, a sixth lens 560, and a seventh lens 570, and may further include a filter 580 and an image sensor IS.

The optical imaging system in the fifth embodiment may form a focus on the imaging plane 590. The imaging plane 590 may refer to a surface on which a focus may be formed by the optical imaging system. For example, the imaging plane 590 may refer to one surface of the image sensor IS on which light is incident.

The lens characteristics of each lens (a radius of curvature, a thickness of the lens or a distance between the lenses, a refractive index, an Abbe number, and a focal length) are listed in Table 9.

TABLE 9

| Surface | | Radius of | Thickness or | Refractive | Abbe | Focal |
|---|---|---|---|---|---|---|
| No. | Elements | curvature | distance | index | number | length |
| S1 | First lens | 2.257 | 0.885 | 1.544 | 56.0 | 5.29 |
| S2 | | 8.866 | 0.100 | | | |
| S3 | Second lens | 7.874 | 0.250 | 1.671 | 19.2 | −15.8 |
| S4 | | 4.483 | 0.373 | | | |
| S5 | Third lens | 12.910 | 0.363 | 1.544 | 56.0 | 58.08 |
| S6 | | 21.552 | 0.312 | | | |
| S7 | Fourth lens | −68.037 | 0.337 | 1.671 | 19.2 | 81.93 |
| S8 | | −30.664 | 0.376 | | | |
| S9 | Fifth lens | −36.098 | 0.316 | 1.614 | 25.9 | −22.78 |
| S10 | | 23.282 | 0.455 | | | |
| S11 | Sixth lens | 3.906 | 0.676 | 1.567 | 37.4 | 9.35 |
| S12 | | 13.676 | 0.655 | | | |
| S13 | Seventh lens | 6.428 | 0.628 | 1.535 | 55.7 | −5.57 |
| S14 | | 1.972 | 0.206 | | | |
| S15 | Filter | Infinity | 0.110 | 1.517 | 64.2 | |
| S16 | | Infinity | 0.853 | | | |
| S17 | Imaging plane | Infinity | | | | |

The total focal length f of the optical imaging system in the fifth embodiment may be 6.1 mm, IMG HT may be 5.605 mm, FOV may be 83.61°, Fno may be 1.95, ET1 may be 0.267 mm, SWA71 may be 24.55°, and SWA72 may be 37.23°.

In the fifth embodiment, the first lens 510 may have positive refractive power, the first surface of the first lens 510 may be convex, and the second surface of the first lens 510 may be concave.

The second lens 520 may have negative refractive power, a first surface of the second lens 520 may be convex, and a second surface of the second lens 520 may be concave.

The third lens 530 may have positive refractive power, a first surface of the third lens 530 may be convex, and a second surface of the third lens 530 may be concave.

The fourth lens 540 may have positive refractive power, the first surface of the fourth lens 540 may be concave, and the second surface of the fourth lens 540 may be convex.

The fifth lens 550 may have negative refractive power, the first surface of the fifth lens 550 may be concave, and the second surface of the fifth lens 550 may be concave.

The sixth lens 560 may have positive refractive power, the first surface of the sixth lens 560 may be convex in the paraxial region, and the second surface of the sixth lens 560 may be concave in the paraxial region.

Also, at least one inflection point may be formed on at least one of the first and second surfaces of the sixth lens 560. For example, the first surface of the sixth lens 560 may be convex in the paraxial region and may be concave in a portion other than the paraxial region. Also, the second surface of the sixth lens 560 may be concave in the paraxial region and may be convex in a portion other than the paraxial region.

The seventh lens 570 may have negative refractive power, the first surface of the seventh lens 570 may be convex in the paraxial region, and the second surface of the seventh lens 570 may be concave in the paraxial region.

Also, at least one inflection point may be formed on at least one of the first and second surfaces of the seventh lens 570. For example, the first surface of the seventh lens 570 may be convex in the paraxial region and may be concave in a portion other than the paraxial region. Also, the second surface of the seventh lens 570 may be concave in the paraxial region and may be convex in a portion other than the paraxial region.

Each surface of the first lens 510 to the seventh lens 570 may have an aspherical coefficient as in Table 10. For example, both the object-side surface and the image-side surface of the first lens 510 to the seventh lens 570 may be aspherical.

TABLE 10

| | S1 | S2 | S3 | S4 | S5 | S6 | S7 |
|---|---|---|---|---|---|---|---|
| Conic | −0.607 | −11.660 | 2.657 | 2.658 | 30.922 | −99.000 | 22.865 |
| constant (K) | | | | | | | |
| 4th order | 5.5862E−03 | −1.2119E−02 | −1.3985E−02 | −5.0760E−02 | −2.2512E−02 | −8.7959E−04 | −1.2078E−01 |
| coefficient(A) | | | | | | | |
| 6th order | 5.6988E−03 | −3.1869E−02 | −2.1901E−01 | 5.8780E−01 | 3.3128E−02 | −3.2989E−01 | 6.8497E−01 |
| coefficient(B) | | | | | | | |
| 8th order | −3.3796E−02 | 1.8949E−01 | 1.7782E+00 | −5.4836E+00 | −4.7018E−01 | 2.3209E+00 | −4.0310E+00 |
| coefficient(C) | | | | | | | |
| 10th order | 1.5870E−01 | −3.4050E−01 | −7.5313E+00 | 3.1254E+01 | 2.9970E+00 | −1.0344E+01 | 1.5296E+01 |
| coefficient(D) | | | | | | | |
| 12th order | −4.5626E−01 | −1.5773E−01 | 2.0508E+01 | −1.1514E+02 | −1.1407E+01 | 3.1144E+01 | −3.9548E+01 |
| coefficient(E) | | | | | | | |
| 14th order | 8.4000E−01 | 1.9143E+00 | −3.8275E+01 | 2.8939E+02 | 2.8861E+01 | −6.5938E+01 | 7.1894E+01 |
| coefficient(F) | | | | | | | |
| 16th order | −1.0346E+00 | −4.1481E+00 | 5.0693E+01 | −5.1292E+02 | −5.0928E+01 | 1.0048E+02 | −9.3767E+01 |
| coefficient(G) | | | | | | | |
| 18th order | 8.7694E−01 | 5.0383E+00 | −4.8503E+01 | 6.5222E+02 | 6.4141E+01 | −1.1137E+02 | 8.8558E+01 |
| coefficient(H) | | | | | | | |
| 20th order | −5.1851E−01 | −3.9532E+00 | 3.3673E+01 | −5.9762E+02 | −5.8052E+01 | 8.9762E+01 | −6.0484E+01 |
| coefficient(J) | | | | | | | |
| 22nd order | 2.1353E−01 | 2.0833E+00 | −1.6809E+01 | 3.9119E+02 | 3.7477E+01 | −5.1996E+01 | 2.9476E+01 |
| coefficient(L) | | | | | | | |
| 24th order | −6.0058E−02 | −7.3543E−01 | 5.8794E+00 | −1.7839E+02 | −1.6839E+01 | 2.1064E+01 | −9.9490E+00 |
| coefficient(M) | | | | | | | |
| 26th order | 1.1004E−02 | 1.6725E−01 | −1.3674E+00 | 5.3816E+01 | 5.0021E+00 | −5.6588E+00 | 2.1974E+00 |
| coefficient(N) | | | | | | | |
| 28th order | −1.1842E−03 | −2.2187E−02 | 1.8982E−01 | −9.6506E+00 | −8.8275E−01 | 9.0501E−01 | −2.8346E−01 |
| coefficient(O) | | | | | | | |
| 30th order | 5.7000E−05 | 1.3062E−03 | −1.1896E−02 | 7.7861E−01 | 7.0049E−02 | −6.5176E−02 | 1.6009E−02 |
| coefficient(P) | | | | | | | |
| | S8 | S9 | S10 | S11 | S12 | S13 | S14 |
| Conic | −99.000 | 2.377 | 22.600 | −14.857 | −87.161 | −16.434 | −7.370 |
| constant (K) | | | | | | | |
| 4th order | −7.7739E−02 | −9.1027E−02 | −1.0765E−01 | 3.3973E−03 | 8.5774E−03 | −1.3207E−01 | −6.8240E−02 |
| coefficient(A) | | | | | | | |
| 6th order | 2.9936E−01 | 7.4647E−02 | 5.6706E−04 | −3.6385E−02 | −3.1115E−03 | 6.1764E−02 | 3.0610E−02 |
| coefficient(B) | | | | | | | |
| 8th order | −1.5776E+00 | −2.1749E−01 | 1.3131E−01 | 3.0873E−02 | −1.1929E−02 | −2.7647E−02 | −1.2609E−02 |
| coefficient(C) | | | | | | | |
| 10th order | 5.3992E+00 | 7.1847E−01 | −2.3681E−01 | −2.1217E−02 | 1.1470E−02 | 1.0650E−02 | 4.0327E−03 |
| coefficient(D) | | | | | | | |
| 12th order | −1.2449E+01 | −1.4754E+00 | 2.5665E−01 | 1.0874E−02 | −5.7038E−03 | −2.9162E−03 | −9.3387E−04 |
| coefficient(E) | | | | | | | |
| 14th order | 1.9933E+01 | 1.9652E+00 | −1.9107E−01 | −3.9022E−03 | 1.8744E−03 | 5.5307E−04 | 1.5556E−04 |
| coefficient(F) | | | | | | | |
| 16th order | −2.2692E+01 | −1.8009E+00 | 1.0083E−01 | 9.1856E−04 | −4.4111E−04 | −7.4000E−05 | −1.9000E−05 |
| coefficient(G) | | | | | | | |
| 18th order | 1.8608E+01 | 1.1706E+00 | −3.8062E−02 | −1.2934E−04 | 7.7000E−05 | 7.0000E−06 | 2.0000E−06 |
| coefficient(H) | | | | | | | |
| 20th order | −1.1013E+01 | −5.4530E−01 | 1.0270E−02 | 8.0000E−06 | −1.0000E−05 | −4.9552E−07 | −1.0473E−07 |
| coefficient(J) | | | | | | | |
| 22nd order | 4.6574E+00 | 1.8100E−01 | −1.9598E−03 | 1.0000E−06 | 1.0000E−06 | 2.4714E−08 | 4.7821E−09 |
| coefficient(L) | | | | | | | |
| 24th order | −1.3709E+00 | −4.1793E−02 | 2.5793E−04 | −1.5483E−07 | −6.9060E−08 | −8.6260E−10 | −1.5249E−10 |
| coefficient(M) | | | | | | | |
| 26th order | 2.6651E−01 | 6.3755E−03 | −2.2000E−05 | 1.3231E−08 | 3.3395E−09 | 2.0008E−11 | 3.2216E−12 |
| coefficient(N) | | | | | | | |
| 28th order | −3.0721E−02 | −5.7697E−04 | 1.0000E−06 | −5.5018E−10 | −9.8763E−11 | −2.7704E−13 | −4.0486E−14 |
| coefficient(O) | | | | | | | |
| 30th order | 1.5879E−03 | 2.3000E−05 | −2.5751E−08 | 9.3457E−12 | 1.3416E−12 | 1.7325E−15 | 2.2891E−16 |
| coefficient(P) | | | | | | | |

Also, the optical imaging system configured as described above may have the aberration characteristics illustrated in FIG. 10.

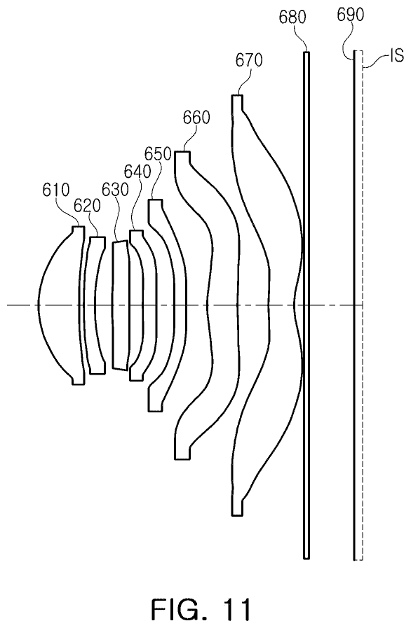

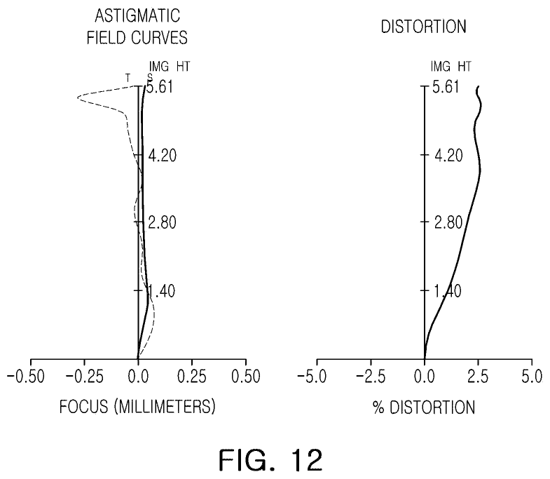

An optical imaging system according to a sixth embodiment will be described with reference to FIGS. 11 and 12.

The optical imaging system in the sixth embodiment may include an optical system including a first lens 610, a second lens 620, a third lens 630, a fourth lens 640, a fifth lens 650, a sixth lens 660, and a seventh lens 670, and may further include a filter 680 and an image sensor IS.

The optical imaging system in the sixth embodiment may form a focus on the imaging plane 690. The imaging plane 690 may refer to a surface on which a focus may be formed by the optical imaging system. For example, the imaging plane 690 may refer to one surface of the image sensor IS on which light is incident.

The lens characteristics of each lens (a radius of curvature, a thickness of the lens or a distance between the lenses, a refractive index, an Abbe number, and a focal length) are listed in Table 11.

TABLE 11

| Surface | | Radius of | Thickness or | Refractive | Abbe | Focal |
|---|---|---|---|---|---|---|
| No. | Elements | curvature | distance | index | number | length |
| S1 | First lens | 2.256 | 0.889 | 1.544 | 56.0 | 5.27 |
| S2 | | 9.004 | 0.100 | | | |
| S3 | Second lens | 8.990 | 0.250 | 1.671 | 19.2 | −17.53 |
| S4 | | 5.064 | 0.375 | | | |
| S5 | Third lens | 22.900 | 0.359 | 1.544 | 56.0 | −5475.55 |
| S6 | | 22.600 | 0.307 | | | |
| S7 | Fourth lens | 46.578 | 0.288 | 1.671 | 19.2 | −2335.33 |
| S8 | | 45.136 | 0.381 | | | |
| S9 | Fifth lens | 101.679 | 0.268 | 1.614 | 25.9 | −44.68 |
| S10 | | 21.748 | 0.472 | | | |
| S11 | Sixth lens | 3.995 | 0.662 | 1.567 | 37.4 | 9.15 |
| S12 | | 15.988 | 0.670 | | | |
| S13 | Seventh lens | 6.917 | 0.573 | 1.535 | 55.7 | −6.14 |
| S14 | | 2.169 | 0.206 | | | |
| S15 | Filter | Infinity | 0.110 | 1.517 | 64.2 | |
| S16 | | Infinity | 0.981 | | | |
| S17 | Imaging plane | Infinity | | | | |

The total focal length f of the optical imaging system in the sixth embodiment may be 6.18 mm, IMG HT may be 5.605 mm, FOV may be 83.01°, Fno may be 1.951, ET1 may be 0.256 mm, SWA71 may be 24.89°, and SWA72 may be 34.47°.

In the sixth embodiment, the first lens 610 may have positive refractive power, the first surface of the first lens 610 may be convex, and the second surface of the first lens 610 may be concave.

The second lens 620 may have negative refractive power, a first surface of the second lens 620 may be convex, and a second surface of the second lens 620 may be concave.

The third lens 630 may have negative refractive power, a first surface of the third lens 630 may be convex, and a second surface of the third lens 630 may be concave.

The fourth lens 640 may have negative refractive power, the first surface of the fourth lens 640 may be convex, and the second surface of the fourth lens 640 may be concave.

The fifth lens 650 may have negative refractive power, the first surface of the fifth lens 650 may be convex, and the second surface of the fifth lens 650 may be concave.

The sixth lens 660 may have positive refractive power, the first surface of the sixth lens 660 may be convex in the paraxial region, and the second surface of the sixth lens 660 may be concave in the paraxial region.

Also, at least one inflection point may be formed on at least one of the first and second surfaces of the sixth lens 660. For example, the first surface of the sixth lens 660 may be convex in the paraxial region and may be concave in a portion other than the paraxial region. The second surface of the sixth lens 660 may be concave in the paraxial region and may be convex in a portion other than the paraxial region.

The seventh lens 670 may have negative refractive power, the first surface of the seventh lens 670 may be convex in the paraxial region, and the second surface of the seventh lens 670 may be concave in the paraxial region.

Also, at least one inflection point may be formed on at least one of the first and second surfaces of the seventh lens 670. For example, the first surface of the seventh lens 670 may be convex in the paraxial region and may be concave in a portion other than the paraxial region. Also, the second surface of the seventh lens 670 may be concave in the paraxial region and may be convex in a portion other than the paraxial region.

Each surface of the first lens 610 to the seventh lens 670 may have an aspherical coefficient as in Table 12. For example, both the object-side surface and the image-side surface of the first lens 610 to the seventh lens 670 may be aspherical.

TABLE 12

| | S1 | S2 | S3 | S4 | S5 | s6 | S7 |
|---|---|---|---|---|---|---|---|
| Conic | −0.609 | −14.745 | 3.388 | 2.874 | −2.922 | −86.330 | 91.342 |
| constant (K) | | | | | | | |
| 4th order | −7.4248E−03 | −1.6899E−02 | −1.5548E−02 | −3.8371E−02 | −1.7169E−02 | −1.6786E−02 | −9.0755E−02 |
| coefficient(A) | | | | | | | |
| 6th order | 1.0381E−01 | 3.2398E−02 | −1.2294E−01 | 2.5617E−01 | −3.1923E−02 | −2.4928E−01 | 3.7782E−01 |
| coefficient(B) | | | | | | | |
| 8th order | −4.3881E−01 | −1.8212E−01 | 8.9146E−01 | −1.5113E+00 | −1.6630E−01 | 2.0064E+00 | −2.0658E+00 |
| coefficient(C) | | | | | | | |
| 10th order | 1.1672E+00 | 8.0715E−01 | −3.3665E+00 | 5.5520E+00 | 2.0496E+00 | −9.3247E+00 | 7.0666E+00 |
| coefficient(D) | | | | | | | |
| 12th order | −2.0600E+00 | −2.2433E+00 | 8.4296E+00 | −1.2034E+01 | −9.1357E+00 | 2.8419E+01 | −1.6034E+01 |
| coefficient(E) | | | | | | | |
| 14th order | 2.5176E+00 | 4.1449E+00 | −1.4753E+01 | 1.3522E+01 | 2.4497E+01 | −6.0106E+01 | 2.4732E+01 |
| coefficient(F) | | | | | | | |
| 16th order | −2.1899E+00 | −5.3083E+00 | 1.8526E+01 | −1.2230E−02 | −4.4256E+01 | 9.0915E+01 | −2.6123E+01 |
| coefficient(G) | | | | | | | |
| 18th order | 1.3769E+00 | 4.8154E+00 | −1.6904E+01 | −2.4749E+01 | 5.6216E+01 | −9.9707E+01 | 1.8523E+01 |
| coefficient(H) | | | | | | | |
| 20th order | −6.2844E−01 | −3.1157E+00 | 1.1226E+01 | 4.1100E+01 | −5.0934E+01 | 7.9385E+01 | −8.1454E+00 |
| coefficient(J) | | | | | | | |
| 22nd order | 2.0664E−01 | 1.4281E+00 | −5.3680E+00 | −3.6635E+01 | 3.2775E+01 | −4.5381E+01 | 1.5616E+00 |
| coefficient(L) | | | | | | | |
| 24th order | −4.7802E−02 | −4.5281E−01 | 1.7999E+00 | 2.0256E+01 | −1.4637E+01 | 1.8133E+01 | 3.9365E−01 |
| coefficient(M) | | | | | | | |
| 26th order | 7.4005E−03 | 9.4431E−02 | −4.0139E−01 | −6.9573E+00 | 4.3124E+00 | −4.8029E+00 | −3.2744E−01 |
| coefficient(N) | | | | | | | |
| 28th order | −6.9005E−04 | −1.1649E−02 | 5.3436E−02 | 1.3657E+00 | −7.5359E−01 | 7.5712E−01 | 8.0990E−02 |
| coefficient(O) | | | | | | | |
| 30th order | 2.9000E−05 | 6.4389E−04 | −3.2116E−03 | −1.1745E−01 | 5.9130E−02 | −5.3733E−02 | −7.5053E−03 |
| coefficient(P) | | | | | | | |
| | S8 | S9 | S10 | S11 | S12 | S13 | S14 |
| Conic | 67.134 | 70.112 | −10.649 | −14.977 | −90.132 | −15.802 | −7.769 |
| constant (K) | | | | | | | |
| 4th order | −6.3004E−02 | −8.7392E−02 | −1.0033E−01 | 2.4139E−03 | 8.9593E−03 | −1.3301E−01 | −7.0833E−02 |
| coefficient(A) | | | | | | | |
| 6th order | 1.2772E−01 | 2.5298E−02 | −4.2575E−02 | −3.0746E−02 | −3.3273E−03 | 6.1663E−02 | 2.9042E−02 |
| coefficient(B) | | | | | | | |
| 8th order | −5.3088E−01 | −5.0129E−02 | 2.4371E−01 | 2.0118E−02 | −1.4408E−02 | −2.7174E−02 | −1.0318E−02 |
| coefficient(C) | | | | | | | |
| 10th order | 1.4945E+00 | 4.0250E−01 | −4.2733E−01 | −9.7825E−03 | 1.5545E−02 | 1.0289E−02 | 2.7913E−03 |
| coefficient(D) | | | | | | | |
| 12th order | −2.8893E+00 | −1.1362E+00 | 4.7731E−01 | 3.2243E−03 | −8.7980E−03 | −2.7536E−03 | −5.2714E−04 |
| coefficient(E) | | | | | | | |
| 14th order | 3.8862E+00 | 1.8112E+00 | −3.6845E−01 | −4.6995E−04 | 3.2947E−03 | 5.0616E−04 | 6.5000E−05 |
| coefficient(F) | | | | | | | |
| 16th order | −3.7058E+00 | −1.8855E+00 | 2.0112E−01 | −1.5179E−04 | −8.7312E−04 | −6.5000E−05 | −5.0000E−06 |
| coefficient(G) | | | | | | | |
| 18th order | 2.5298E+00 | 1.3534E+00 | −7.8314E−02 | 1.0705E−04 | 1.6763E−04 | 6.0000E−06 | 6.3413E−08 |
| coefficient(H) | | | | | | | |
| 20th order | −1.2326E+00 | −6.8319E−01 | 2.1757E−02 | −2.9000E−05 | −2.3000E−05 | −3.8763E−07 | 2.2914E−08 |
| coefficient(J) | | | | | | | |
| 22nd order | 4.2036E−01 | 2.4231E−01 | −4.2708E−03 | 5.0000E−06 | 2.0000E−06 | 1.7870E−08 | −2.5390E−09 |
| coefficient(L) | | | | | | | |
| 24th order | −9.6063E−02 | −5.9137E−02 | 5.7778E−04 | −4.7348E−07 | −1.6621E−07 | −5.6617E−10 | 1.3801E−10 |
| coefficient(M) | | | | | | | |
| 26th order | 1.3443E−02 | 9.4548E−03 | −5.1000E−05 | 2.9345E−08 | 7.8144E−09 | 1.1644E−11 | −4.3432E−12 |
| coefficient(N) | | | | | | | |
| 28th order | −9.3371E−04 | −8.9095E−04 | 3.0000E−06 | −1.0318E−09 | −2.1981E−10 | −1.3840E−13 | 7.5630E−14 |
| coefficient(O) | | | | | | | |
| 30th order | 1.4000E−05 | 3.7000E−05 | −6.2416E−08 | 1.5788E−11 | 2.7986E−12 | 7.0790E−16 | −5.6627E−16 |
| coefficient(P) | | | | | | | |

Also, the optical imaging system configured as described above may have the aberration characteristics illustrated in FIG. 12.

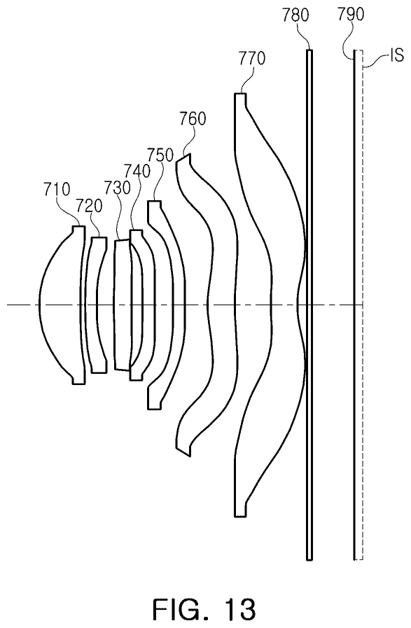

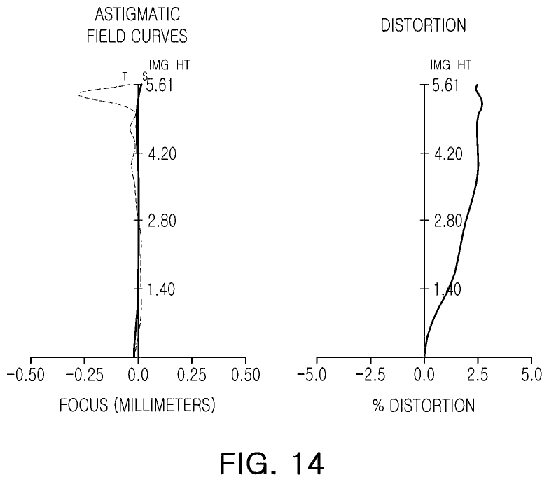

An optical imaging system according to a seventh embodiment will be described with reference to FIGS. 13 and 14.

The optical imaging system in the seventh embodiment may include an optical system including a first lens 710, a second lens 720, a third lens 730, a fourth lens 740, a fifth lens 750, a sixth lens 760, and a seventh lens 770, and may further include a filter 780 and an image sensor IS.

The optical imaging system in the seventh embodiment may form a focus on the imaging plane 790. The imaging plane 790 may refer to a surface on which a focus may be formed by the optical imaging system. For example, the imaging plane 790 may refer to one surface of the image sensor IS on which light is incident.

The lens characteristics of each lens (a radius of curvature, a thickness of the lens or a distance between the lenses, a refractive index, an Abbe number, and a focal length) are listed in Table 13.

TABLE 13

| Surface | | Radius of | Thickness or | Refractive | Abbe | Focal |
|---|---|---|---|---|---|---|
| No. | Elements | curvature | distance | index | number | length |
| S1 | First lens | 2.243 | 0.903 | 1.544 | 56.0 | 5.12 |
| S2 | | 9.697 | 0.100 | | | |
| S3 | Second lens | 8.715 | 0.250 | 1.671 | 19.2 | −15.3 |
| S4 | | 4.683 | 0.391 | | | |
| S5 | Third lens | 24.000 | 0.372 | 1.535 | 55.7 | −525.68 |
| S6 | | 22.000 | 0.229 | | | |
| S7 | Fourth lens | 41.598 | 0.288 | 1.671 | 19.2 | −200.62 |
| S8 | | 31.776 | 0.384 | | | |
| S9 | Fifth lens | 49.265 | 0.263 | 1.614 | 25.9 | −78.19 |
| S10 | | 24.384 | 0.495 | | | |
| S11 | Sixth lens | 3.866 | 0.609 | 1.567 | 37.4 | 9.72 |
| S12 | | 12.018 | 0.781 | | | |
| S13 | Seventh lens | 6.441 | 0.579 | 1.535 | 55.7 | −6.2 |
| S14 | | 2.126 | 0.206 | | | |
| S15 | Filter | Infinity | 0.110 | 1.517 | 64.2 | |
| S16 | | Infinity | 0.940 | | | |
| S17 | Imaging plane | Infinity | | | | |

The total focal length f of the optical imaging system in the seventh embodiment may be 6.17 mm, IMG HT may be 5.605 mm, FOV may be 83°, Fno may be 1.951, ET1 may be 0.257 mm, SWA71 may be 25.02°, and SWA72 may be 34.02°.

In the seventh embodiment, the first lens 710 may have positive refractive power, the first surface of the first lens 710 may be convex, and the second surface of the first lens 710 may be concave.

The second lens 720 may have negative refractive power, the first surface of the second lens 720 may be convex, and a second surface of the second lens 720 may be concave.

The third lens 730 may have negative refractive power, the first surface of the third lens 730 may be convex, and a second surface of the third lens 730 may be concave.

The fourth lens 740 may have negative refractive power, the first surface of the fourth lens 740 may be convex, and the second surface of the fourth lens 740 may be concave.

The fifth lens 750 may have negative refractive power, the first surface of the fifth lens 750 may be convex, and the second surface of the fifth lens 750 may be concave.

The sixth lens 760 may have positive refractive power, the first surface of the sixth lens 760 may be convex in the paraxial region, and the second surface of the sixth lens 760 may be concave in the paraxial region.

Also, at least one inflection point may be formed on at least one of the first and second surfaces of the sixth lens 760. For example, the first surface of the sixth lens 760 may be convex in the paraxial region and may be concave in a portion other than the paraxial region. The second surface of the sixth lens 760 may be concave in the paraxial region and may be convex in a portion other than the paraxial region.

The seventh lens 770 may have negative refractive power, the first surface of the seventh lens 770 may be convex in the paraxial region, and the second surface of the seventh lens 770 may be concave in the paraxial region.

Also, at least one inflection point may be formed on at least one of the first and second surfaces of the seventh lens 770. For example, the first surface of the seventh lens 770 may be convex in the paraxial region and may be concave in a portion other than the paraxial region. The second surface of the seventh lens 770 may be concave in the paraxial region and may be convex in a portion other than the paraxial region.

Each surface of the first lens 710 to the seventh lens 770 may have an aspherical coefficient as in Table 14. For example, both the object-side surface and the image-side surface of the first lens 710 to the seventh lens 770 may be aspherical.

TABLE 14

| | S1 | S2 | S3 | S4 | S5 | S6 | S7 |
|---|---|---|---|---|---|---|---|
| Conic | −0.603 | −16.514 | 5.695 | 3.574 | 95.163 | −99.000 | 31.648 |
| constant (K) | | | | | | | |
| 4th order | 2.4393E−03 | −2.1974E−02 | −3.7971E−02 | −1.7300E−02 | −2.3358E−02 | −2.5136E−02 | −5.7717E−02 |
| coefficient(A) | | | | | | | |
| 6th order | 3.2632E−02 | 3.9371E−02 | 9.6621E−02 | −3.2264E−02 | −2.3553E−04 | −1.5880E−01 | −3.3953E−02 |
| coefficient(B) | | | | | | | |
| 8th order | −1.3765E−01 | −1.4872E−01 | −5.0617E−01 | 4.8977E−01 | −1.2162E−01 | 1.4362E+00 | 4.2195E−01 |
| coefficient(C) | | | | | | | |
| 10th order | 3.6678E−01 | 5.5521E−01 | 2.3560E+00 | −2.5762E+00 | 1.2687E+00 | −6.9566E+00 | −2.3188E+00 |
| coefficient(D) | | | | | | | |
| 12th order | −6.4067E−01 | −1.4101E+00 | −7.1599E+00 | 8.7910E+00 | −5.8769E+00 | 2.1580E+01 | 7.9009E+00 |
| coefficient(E) | | | | | | | |
| 14th order | 7.6410E−01 | 2.4580E+00 | 1.4648E+01 | −2.0858E+01 | 1.6481E+01 | −4.5763E+01 | −1.8317E+01 |
| coefficient(F) | | | | | | | |
| 16th order | −6.3695E−01 | −3.0276E+00 | −2.0899E+01 | 3.5387E+01 | −3.0838E+01 | 6.8638E+01 | 2.9875E+01 |
| coefficient(G) | | | | | | | |
| 18th order | 3.7469E−01 | 2.6764E+00 | 2.1214E+01 | −4.3496E+01 | 4.0152E+01 | −7.4033E+01 | −3.4816E+01 |
| coefficient(H) | | | | | | | |
| 20th order | −1.5492E−01 | −1.7029E+00 | −1.5418E+01 | 3.8799E+01 | −3.6962E+01 | 5.7635E+01 | 2.9104E+01 |
| coefficient(J) | | | | | | | |
| 22nd order | 4.4117E−02 | 7.7229E−01 | 7.9667E+00 | −2.4853E+01 | 2.3998E+01 | −3.2092E+01 | −1.7304E+01 |
| coefficient(L) | | | | | | | |
| 24th order | −8.2703E−03 | −2.4332E−01 | −2.8576E+00 | 1.1134E+01 | −1.0756E+01 | 1.2460E+01 | 7.1399E+00 |
| coefficient(M) | | | | | | | |
| 26th order | 9.2982E−04 | 5.0566E−02 | 6.7641E−01 | −3.3094E+00 | 3.1674E+00 | −3.2026E+00 | −1.9426E+00 |
| coefficient(N) | | | | | | | |
| 28th order | −5.0000E−05 | −6.2278E−03 | −9.5018E−02 | 5.8588E−01 | −5.5149E−01 | 4.8966E−01 | 3.1332E−01 |
| coefficient(O) | | | | | | | |
| 30th order | 4.7913E−07 | 3.4412E−04 | 5.9997E−03 | −4.6726E−02 | 4.3014E−02 | −3.3704E−02 | −2.2681E−02 |
| coefficient(P) | | | | | | | |
| | S8 | S9 | S10 | S11 | S12 | S13 | S14 |
| Conic | 28.924 | −99.000 | 24.374 | −14.444 | −85.781 | −17.766 | −7.556 |
| constant (K) | | | | | | | |
| 4th order | −4.5868E−02 | −8.7326E−02 | −1.0758E−01 | −3.0393E−03 | 2.7921E−03 | −1.3221E−01 | −6.9713E−02 |
| coefficient(A) | | | | | | | |
| 6th order | −4.5901E−02 | 1.1783E−02 | 5.5136E−03 | −1.5292E−02 | 3.4542E−03 | 6.1716E−02 | 3.0264E−02 |
| coefficient(B) | | | | | | | |
| 8th order | 3.1917E−01 | 8.9266E−02 | 1.2993E−01 | 2.5655E−03 | −1.6890E−02 | −2.7903E−02 | −1.2176E−02 |
| coefficient(C) | | | | | | | |
| 10th order | −1.0873E+00 | −1.3579E−01 | −2.7317E−01 | 4.2365E−03 | 1.5099E−02 | 1.0764E−02 | 3.8520E−03 |
| coefficient(D) | | | | | | | |
| 12th order | 2.3742E+00 | 1.1514E−02 | 3.4117E−01 | −5.0810E−03 | −7.8466E−03 | −2.9049E−03 | −8.9471E−04 |
| coefficient(E) | | | | | | | |
| 14th order | −3.6226E+00 | 2.4064E−01 | −2.8864E−01 | 3.0822E−03 | 2.7445E−03 | 5.3531E−04 | 1.5201E−04 |
| coefficient(F) | | | | | | | |
| 16th order | 3.9879E+00 | −4.1300E−01 | 1.7106E−01 | −1.2229E−03 | −6.7547E−04 | −6.9000E−05 | −1.9000E−05 |
| coefficient(G) | | | | | | | |
| 18th order | −3.2108E+00 | 3.7903E−01 | −7.1870E−02 | 3.3337E−04 | 1.1842E−04 | 6.0000E−06 | 2.0000E−06 |
| coefficient(H) | | | | | | | |
| 20th order | 1.8946E+00 | −2.2352E−01 | 2.1438E−02 | −6.3000E−05 | −1.5000E−05 | −4.0612E−07 | −1.2158E−07 |
| coefficient(J) | | | | | | | |
| 22nd order | −8.1158E−01 | 8.8532E−02 | −4.4995E−03 | 8.0000E−06 | 1.0000E−06 | 1.8615E−08 | 6.1038E−09 |
| coefficient(L) | | | | | | | |
| 24th order | 2.4608E−01 | −2.3497E−02 | 6.4861E−04 | −1.0000E−06 | −7.4536E−08 | −5.8666E−10 | −2.1790E−10 |
| coefficient(M) | | | | | | | |
| 26th order | −5.0160E−02 | 4.0146E−03 | −6.1000E−05 | 4.0354E−08 | 2.7270E−09 | 1.2026E−11 | 5.2438E−12 |
| coefficient(N) | | | | | | | |
| 28th order | 6.1762E−03 | −3.9928E−04 | 3.0000E−06 | −1.3252E−09 | −5.4275E−11 | −1.4315E−13 | −7.6291E−14 |
| coefficient(O) | | | | | | | |
| 30th order | −3.4751E−04 | 1.8000E−05 | −8.3450E−08 | 1.9262E−11 | 4.0519E−13 | 7.4078E−16 | 5.0687E−16 |
| coefficient(P) | | | | | | | |

Also, the optical imaging system configured as described above may have the aberration characteristics illustrated in FIG. 14.

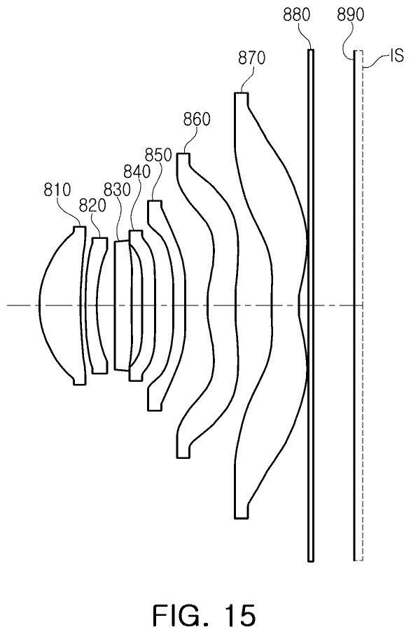

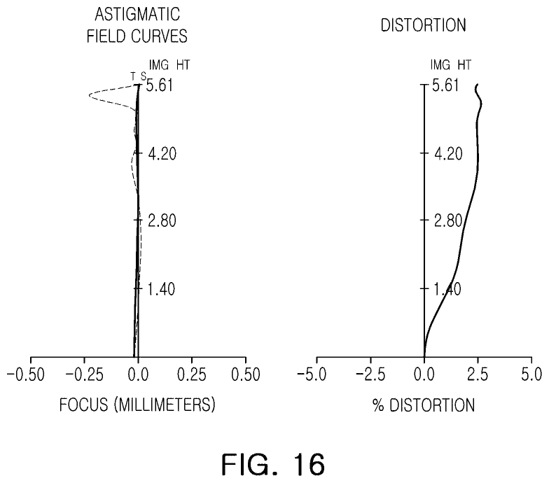

An optical imaging system according to an eighth embodiment will be described with reference to FIGS. 15 and 16.

The optical imaging system in the eighth embodiment may include an optical system including a first lens 810, a second lens 820, a third lens 830, a fourth lens 840, a fifth lens 850, a sixth lens 860, and a seventh lens 870, and may further include a filter 880 and an image sensor IS.

The optical imaging system in the eighth embodiment may form a focus on the imaging plane 890. The imaging plane 890 may refer to a surface on which a focus may be formed by the optical imaging system. For example, the imaging plane 890 may refer to one surface of the image sensor IS on which light is incident.

The lens characteristics of each lens (a radius of curvature, a thickness of the lens or a distance between the lenses, a refractive index, an Abbe number, and a focal length) are listed in Table 15.

TABLE 15

| Surface | | Radius of | Thickness or | Refractive | Abbe | Focal |
|---|---|---|---|---|---|---|
| No. | Elements | curvature | distance | index | number | length |
| S1 | First lens | 2.242 | 0.910 | 1.544 | 56.0 | 5.19 |
| S2 | | 9.188 | 0.100 | | | |
| S3 | Second lens | 7.767 | 0.252 | 1.680 | 18.2 | −15.94 |
| S4 | | 4.490 | 0.390 | | | |
| S5 | Third lens | 23.930 | 0.367 | 1.535 | 55.7 | 412.54 |
| S6 | | 26.684 | 0.226 | | | |
| S7 | Fourth lens | 65.138 | 0.289 | 1.671 | 19.2 | −80.82 |
| S8 | | 29.728 | 0.381 | | | |
| S9 | Fifth lens | 39.382 | 0.279 | 1.614 | 25.9 | −106.86 |
| S10 | | 24.634 | 0.494 | | | |
| S11 | Sixth lens | 3.819 | 0.602 | 1.567 | 37.4 | 9.91 |
| S12 | | 11.078 | 0.793 | | | |
| S13 | Seventh lens | 6.230 | 0.590 | 1.535 | 55.7 | −6.21 |
| S14 | | 2.100 | 0.206 | | | |
| S15 | Filter | Infinity | 0.110 | 1.517 | 64.2 | |
| S16 | | Infinity | 0.901 | | | |
| S17 | Imaging plane | Infinity | | | | |

The total focal length f of the optical imaging system in the eighth embodiment may be 6.16 mm, IMG HT may be 5.605 mm, FOV may be 83.09°, Fno may be 1.951, ET1 may be 0.259 mm, SWA71 may be 24.99°, and SWA72 may be 32.8°.

In the eighth embodiment, the first lens 810 may have positive refractive power, the first surface of the first lens 810 may be convex, and the second surface of the first lens 810 may be concave.

The second lens 820 may have negative refractive power, the first surface of the second lens 820 may be convex, and a second surface of the second lens 820 may be concave.

The third lens 830 may have positive refractive power, the first surface of the third lens 830 may be convex, and a second surface of the third lens 830 may be concave.

The fourth lens 840 may have negative refractive power, the first surface of the fourth lens 840 may be convex, and the second surface of the fourth lens 840 may be concave.

The fifth lens 850 may have negative refractive power, the first surface of the fifth lens 850 may be convex, and the second surface of the fifth lens 850 may be concave.

The sixth lens 860 may have positive refractive power, the first surface of the sixth lens 860 may be convex in the paraxial region, and the second surface of the sixth lens 860 may be concave in the paraxial region.

Also, at least one inflection point may be formed on at least one of the first and second surfaces of the sixth lens 860. For example, the first surface of the sixth lens 860 may be convex in the paraxial region and may be concave in a portion other than the paraxial region. The second surface of the sixth lens 860 may be concave in the paraxial region and may be convex in a portion other than the paraxial region.

The seventh lens 870 may have negative refractive power, the first surface of the seventh lens 870 may be convex in the paraxial region, and the second surface of the seventh lens 870 may be concave in the paraxial region.

Also, at least one inflection point may be formed on at least one of the first and second surfaces of the seventh lens 870. For example, the first surface of the seventh lens 870 may be convex in the paraxial region and may be concave in a portion other than the paraxial region. The second surface of the seventh lens 870 may be concave in the paraxial region and may be convex in a portion other than the paraxial region.

Each surface of the first lens 810 to the seventh lens 870 may have an aspherical coefficient as in Table 16. For example, both the object-side surface and the image-side surface of the first lens 810 to the seventh lens 870 may be aspherical.

TABLE 16

| | S1 | S2 | S3 | S4 | S5 | S6 | S7 |
|---|---|---|---|---|---|---|---|
| Conic | −0.608 | −15.011 | 6.172 | 3.622 | 99.000 | −68.974 | 99.000 |
| constant (K) | | | | | | | |
| 4th order | 5.9060E−03 | −2.5721E−02 | −4.2594E−02 | −1.3171E−02 | −2.6668E−02 | −2.5441E−02 | −5.5831E−02 |
| coefficient(A) | | | | | | | |
| 6th order | 3.6446E−03 | 7.3900E−02 | 1.4836E−01 | −8.4169E−02 | 3.3494E−02 | −1.3207E−01 | −5.7729E−02 |
| coefficient(B) | | | | | | | |
| 8th order | −3.2771E−03 | −3.2258E−01 | −8.2719E−01 | 8.6489E−01 | −2.5282E−01 | 1.2414E+00 | 5.6429E−01 |
| coefficient(C) | | | | | | | |
| 10th order | −1.7173E−02 | 1.1299E+00 | 3.6548E+00 | −4.2741E+00 | 1.5551E+00 | −6.1505E+00 | −2.8101E+00 |
| coefficient(D) | | | | | | | |
| 12th order | 8.1397E−02 | −2.7158E+00 | −1.0788E+01 | 1.3891E+01 | −6.2343E+00 | 1.9364E+01 | 8.9683E+00 |
| coefficient(E) | | | | | | | |
| 14th order | −1.6949E−01 | 4.5553E+00 | 2.1843E+01 | −3.1469E+01 | 1.6709E+01 | −4.1442E+01 | −1.9813E+01 |
| coefficient(F) | | | | | | | |
| 16th order | 2.1585E−01 | −5.4515E+00 | −3.1190E+01 | 5.1089E+01 | −3.0928E+01 | 6.2468E+01 | 3.1199E+01 |
| coefficient(G) | | | | | | | |
| 18th order | −1.8376E−01 | 4.7096E+00 | 3.1911E+01 | −6.0262E+01 | 4.0384E+01 | −6.7510E+01 | −3.5458E+01 |
| coefficient(H) | | | | | | | |
| 20th order | 1.0803E−01 | −2.9400E+00 | −2.3489E+01 | 5.1766E+01 | −3.7505E+01 | 5.2549E+01 | 2.9126E+01 |
| coefficient(J) | | | | | | | |
| 22nd order | −4.4086E−02 | 1.3120E+00 | 1.2333E+01 | −3.2068E+01 | 2.4634E+01 | −2.9214E+01 | −1.7116E+01 |
| coefficient(L) | | | | | | | |
| 24th order | 1.2275E−02 | −4.0771E−01 | −4.5066E+00 | 1.3961E+01 | −1.1184E+01 | 1.1315E+01 | 7.0122E+00 |
| coefficient(M) | | | | | | | |
| 26th order | −2.2253E−03 | 8.3724E−02 | 1.0887E+00 | −4.0535E+00 | 3.3384E+00 | −2.9000E+00 | −1.9013E+00 |
| coefficient(N) | | | | | | | |
| 28th order | 2.3676E−04 | −1.0205E−02 | −1.5631E−01 | 7.0489E−01 | −5.8942E−01 | 4.4206E−01 | 3.0651E−01 |
| coefficient(O) | | | | | | | |
| 30th order | −1.1000E−05 | 5.5878E−04 | 1.0098E−02 | −5.5531E−02 | 4.6631E−02 | −3.0340E−02 | −2.2235E−02 |
| coefficient(P) | | | | | | | |
| | S8 | S9 | S10 | S11 | S12 | S13 | S14 |
| Conic | −50.600 | −87.504 | 36.203 | −14.401 | −84.615 | −18.345 | −7.442 |
| constant (K) | | | | | | | |
| 4th order | −4.8870E−02 | −9.1266E−02 | −1.1181E−01 | −5.2641E−03 | 5.5197E−04 | −1.3188E−01 | −6.8866E−02 |
| coefficient(A) | | | | | | | |
| 6th order | −4.0188E−02 | 4.4433E−02 | 3.8097E−02 | −1.1933E−02 | 5.7837E−03 | 6.1671E−02 | 3.0264E−02 |
| coefficient(B) | | | | | | | |
| 8th order | 3.3436E−01 | −2.4655E−03 | 4.2139E−02 | 1.5626E−03 | −1.7034E−02 | −2.7998E−02 | −1.2419E−02 |
| coefficient(C) | | | | | | | |
| 10th order | −1.2302E+00 | 4.8746E−03 | −1.3192E−01 | 2.3928E−03 | 1.3777E−02 | 1.0826E−02 | 3.9745E−03 |
| coefficient(D) | | | | | | | |
| 12th order | 2.8475E+00 | −1.1081E−01 | 1.8730E−01 | −2.5324E−03 | −6.5972E−03 | −2.9259E−03 | −9.2677E−04 |
| coefficient(E) | | | | | | | |
| 14th order | −4.5539E+00 | 2.7993E−01 | −1.7062E−01 | 1.4419E−03 | 2.1200E−03 | 5.4008E−04 | 1.5712E−04 |
| coefficient(F) | | | | | | | |
| 16th order | 5.2089E+00 | −3.7540E−01 | 1.0611E−01 | −5.6310E−04 | −4.7338E−04 | −7.0000E−05 | −2.0000E−05 |
| coefficient(G) | | | | | | | |
| 18th order | −4.3248E+00 | 3.2081E−01 | −4.5976E−02 | 1.5455E−04 | 7.3000E−05 | 6.0000E−06 | 2.0000E−06 |
| coefficient(H) | | | | | | | |
| 20th order | 2.6128E+00 | −1.8485E−01 | 1.3953E−02 | −2.9000E−05 | −8.0000E−06 | −4.1488E−07 | −1.2113E−07 |
| coefficient(J) | | | | | | | |
| 22nd order | −1.1376E+00 | 7.2844E−02 | −2.9467E−03 | 4.0000E−06 | 4.9806E−07 | 1.9180E−08 | 5.9576E−09 |
| coefficient(L) | | | | | | | |
| 24th order | 3.4796E−01 | −1.9383E−02 | 4.2347E−04 | −3.3192E−07 | −1.5215E−08 | −6.1185E−10 | −2.0778E−10 |
| coefficient(M) | | | | | | | |
| 26th order | −7.1015E−02 | 3.3311E−03 | −3.9000E−05 | 1.8393E−08 | −2.3456E−10 | 1.2761E−11 | 4.8764E−12 |
| coefficient(N) | | | | | | | |
| 28th order | 8.6904E−03 | −3.3368E−04 | 2.0000E−06 | −5.8817E−10 | 3.3068E−11 | −1.5574E−13 | −6.9146E−14 |
| coefficient(O) | | | | | | | |
| 30th order | −4.8267E−04 | 1.5000E−05 | −5.1431E−08 | 8.2595E−12 | −7.4785E−13 | 8.3662E−16 | 4.4790E−16 |
| coefficient(P) | | | | | | | |

Also, the optical imaging system configured as described above may have the aberration characteristics illustrated in FIG. 16.

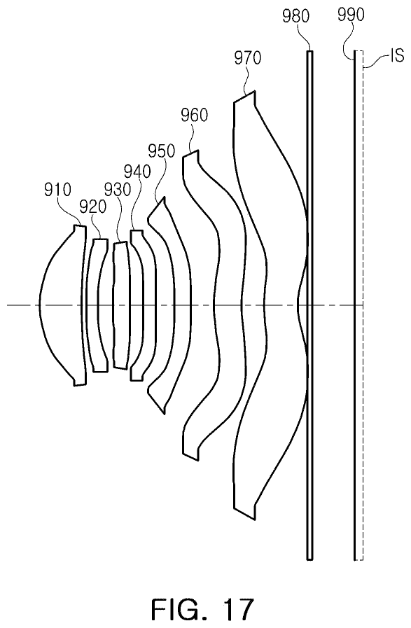

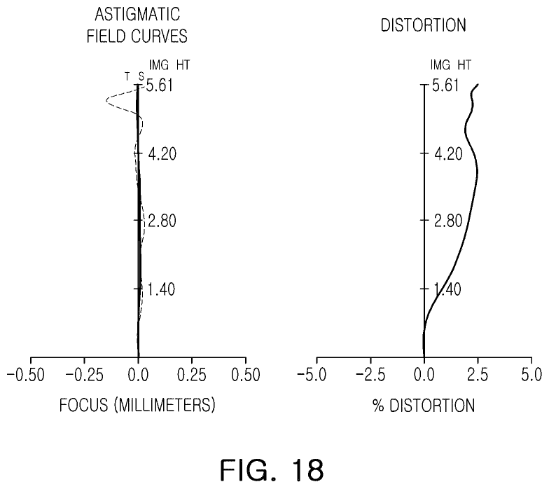

An optical imaging system according to a ninth embodiment will be described with reference to FIGS. 17 and 18.

The optical imaging system in the ninth embodiment may include an optical system including a first lens 910, a second lens 920, a third lens 930, a fourth lens 940, a fifth lens 950, a sixth lens 960, and a seventh lens 970, and may further include a filter 980 and an image sensor IS.

The optical imaging system in the ninth embodiment may form a focus on the imaging plane 990. The imaging plane 990 may refer to a surface on which a focus may be formed by the optical imaging system. For example, the imaging plane 990 may refer to one surface of the image sensor IS on which light is incident.

The lens characteristics of each lens (a radius of curvature, a thickness of the lens or a distance between the lenses, a refractive index, an Abbe number, and a focal length) are listed in Table 17.

TABLE 17

| Surface | | Radius of | Thickness or | Refractive | Abbe | Focal |
|---|---|---|---|---|---|---|
| No. | Elements | curvature | distance | index | number | length |
| S1 | First lens | 2.239 | 0.916 | 1.544 | 56.0 | 5.19 |
| S2 | | 9.086 | 0.100 | | | |
| S3 | Second lens | 7.551 | 0.251 | 1.680 | 18.2 | −15.53 |
| S4 | | 4.367 | 0.346 | | | |
| S5 | Third lens | 22.200 | 0.363 | 1.544 | 56.0 | 71.46 |
| S6 | | 51.165 | 0.287 | | | |
| S7 | Fourth lens | 125.479 | 0.288 | 1.671 | 19.2 | −58.59 |
| S8 | | 30.172 | 0.379 | | | |
| S9 | Fifth lens | 45.850 | 0.383 | 1.567 | 37.4 | 129.41 |
| S10 | | 120.539 | 0.495 | | | |
| S11 | Sixth lens | 3.806 | 0.611 | 1.544 | 56.0 | 49.87 |
| S12 | | 4.174 | 0.489 | | | |
| S13 | Seventh lens | 2.649 | 0.740 | 1.535 | 55.7 | −11.59 |
| S14 | | 1.677 | 0.206 | | | |
| S15 | Filter | Infinity | 0.110 | 1.517 | 64.2 | |
| S16 | | Infinity | 0.925 | | | |
| S17 | Imaging plane | Infinity | | | | |

The total focal length f of the optical imaging system in the ninth embodiment may be 6.1 mm, IMG HT may be 5.605 mm, FOV may be 83.8°, Fno may be 1.951, ET1 may be 0.255 mm, SWA71 may be 23°, and SWA72 may be 30.68°.

In the ninth embodiment, the first lens 910 may have positive refractive power, the first surface of the first lens 910 may be convex, and the second surface of the first lens 910 may be concave.

The second lens 920 may have negative refractive power, the first surface of the second lens 920 may be convex, and a second surface of the second lens 920 may be concave.

The third lens 930 may have positive refractive power, the first surface of the third lens 930 may be convex, and a second surface of the third lens 930 may be concave.

The fourth lens 940 may have negative refractive power, the first surface of the fourth lens 940 may be convex, and the second surface of the fourth lens 940 may be concave.

The fifth lens 950 may have positive refractive power, the first surface of the fifth lens 950 may be convex, and the second surface of the fifth lens 950 may be concave.

The sixth lens 960 may have positive refractive power, the first surface of the sixth lens 960 may be convex in the paraxial region, and the second surface of the sixth lens 960 may be concave in the paraxial region.

Also, at least one inflection point may be formed on at least one of the first and second surfaces of the sixth lens 960. For example, the first surface of the sixth lens 960 may be convex in the paraxial region and may be concave in a portion other than the paraxial region. The second surface of the sixth lens 960 may be concave in the paraxial region and may be convex in a portion other than the paraxial region.

The seventh lens 970 may have negative refractive power, the first surface of the seventh lens 970 may be convex in the paraxial region, and the second surface of the seventh lens 970 may be concave in the paraxial region.

Also, at least one inflection point may be formed on at least one of the first and second surfaces of the seventh lens 970. For example, the first surface of the seventh lens 970 may be convex in the paraxial region and may be concave in a portion other than the paraxial region. The second surface of the seventh lens 970 may be concave in the paraxial region and may be convex in a portion other than the paraxial region.

Each surface of the first lens 910 to the seventh lens 970 may have an aspherical coefficient as in Table 18. For example, both the object-side surface and the image-side surface of the first lens 910 to the seventh lens 970 may be aspherical.

TABLE 18

| | S1 | S2 | S3 | S4 | S5 | S6 | S7 |
|---|---|---|---|---|---|---|---|
| Conic | −0.613 | −14.548 | 6.400 | 3.743 | 78.049 | −99.000 | −86.126 |
| constant (K) | | | | | | | |
| 4th order | 6.3912E−03 | −2.6111E−02 | −4.2150E−02 | −1.1648E−02 | −1.6726E−02 | −3.3519E−02 | −4.8903E−02 |
| coefficient(A) | | | | | | | |
| 6th order | −1.8917E−03 | 7.2793E−02 | 1.5091E−01 | −1.5892E−01 | −6.0955E−02 | 1.8104E−02 | −8.0748E−02 |
| coefficient(B) | | | | | | | |
| 8th order | 3.9178E−02 | −2.5243E−01 | −8.6620E−01 | 1.7243E+00 | 2.9567E−01 | 1.1969E−01 | 4.9612E−01 |
| coefficient(C) | | | | | | | |
| 10th order | −2.0012E−01 | 6.8267E−01 | 3.9225E+00 | −9.5579E+00 | −7.3013E−01 | −1.2664E+00 | −1.7351E+00 |
| coefficient(D) | | | | | | | |
| 12th order | 5.5633E−01 | −1.2619E+00 | −1.1862E+01 | 3.4217E+01 | 5.7233E−01 | 5.4936E+00 | 4.0467E+00 |
| coefficient(E) | | | | | | | |
| 14th order | −9.6942E−01 | 1.6071E+00 | 2.4615E+01 | −8.4130E+01 | 2.2356E+00 | −1.4410E+01 | −6.7699E+00 |
| coefficient(F) | | | | | | | |
| 16th order | 1.1331E+00 | −1.4348E+00 | −3.6067E+01 | 1.4671E+02 | −9.0035E+00 | 2.5262E+01 | 8.3886E+00 |
| coefficient(G) | | | | | | | |
| 18th order | −9.1970E−01 | 9.0328E−01 | 3.7943E+01 | −1.8447E+02 | 1.6871E+01 | −3.0828E+01 | −7.8351E+00 |
| coefficient(H) | | | | | | | |
| 20th order | 5.2578E−01 | −3.9746E−01 | −2.8789E+01 | 1.6790E+02 | −1.9917E+01 | 2.6589E+01 | 5.5534E+00 |
| coefficient(J) | | | | | | | |
| 22nd order | −2.1115E−01 | 1.1869E−01 | 1.5625E+01 | −1.0966E+02 | 1.5747E+01 | −1.6165E+01 | −2.9664E+00 |
| coefficient(L) | | | | | | | |
| 24th order | 5.8324E−02 | −2.2507E−02 | −5.9177E+00 | 5.0121E+01 | −8.3477E+00 | 6.7794E+00 | 1.1626E+00 |
| coefficient(M) | | | | | | | |
| 26th order | −1.0551E−02 | 2.3003E−03 | 1.4856E+00 | −1.5224E+01 | 2.8527E+00 | −1.8671E+00 | −3.1560E−01 |
| coefficient(N) | | | | | | | |
| 28th order | 1.1253E−03 | −5.9000E−05 | −2.2216E−01 | 2.7610E+00 | −5.6846E−01 | 3.0390E−01 | 5.2856E−02 |
| coefficient(O) | | | | | | | |
| 30th order | −5.4000E−05 | −6.0000E−06 | 1.4979E−02 | −2.2626E−01 | 5.0206E−02 | −2.2155E−02 | −4.0939E−03 |
| coefficient(P) | | | | | | | |
| | S8 | S9 | S10 | S11 | S12 | S13 | S14 |
| Conic | −99.000 | −58.183 | 99.000 | −15.036 | −82.284 | −18.996 | −6.837 |
| constant (K) | | | | | | | |
| 4th order | −5.2451E−02 | −1.0423E−01 | −9.4186E−02 | −1.2057E−02 | −1.4498E−03 | −1.3190E−01 | −6.6026E−02 |
| coefficient(A) | | | | | | | |
| 6th order | −3.4189E−02 | 2.1247E−01 | 7.0947E−02 | −4.5922E−03 | 5.9081E−03 | 6.5451E−02 | 2.8535E−02 |
| coefficient(B) | | | | | | | |
| 8th order | 2.6358E−01 | −6.6008E−01 | −1.0857E−01 | 3.2566E−03 | −1.2148E−02 | −3.2123E−02 | −1.0834E−02 |
| coefficient(C) | | | | | | | |
| 10th order | −8.5859E−01 | 1.4710E+00 | 1.3771E−01 | −6.8069E−03 | 7.6075E−03 | 1.3077E−02 | 3.0209E−03 |
| coefficient(D) | | | | | | | |
| 12th order | 1.7866E+00 | −2.2699E+00 | −1.1409E−01 | 6.2718E−03 | −2.7167E−03 | −3.6977E−03 | −5.7173E−04 |
| coefficient(E) | | | | | | | |
| 14th order | −2.6060E+00 | 2.4974E+00 | 6.0999E−02 | −3.2064E−03 | 6.0707E−04 | 7.1918E−04 | 7.0000E−05 |
| coefficient(F) | | | | | | | |
| 16th order | 2.7491E+00 | −2.0076E+00 | −2.0541E−02 | 1.0173E−03 | −8.0000E−05 | −9.9000E−05 | −5.0000E−06 |
| coefficient(G) | | | | | | | |
| 18th order | −2.1239E+00 | 1.1939E+00 | 3.9407E−03 | −2.1126E−04 | 3.0000E−06 | 1.0000E−05 | 5.5113E−08 |
| coefficient(H) | | | | | | | |
| 20th order | 1.2030E+00 | −5.2521E−01 | −2.2046E−04 | 3.0000E−05 | 1.0000E−06 | −1.0000E−06 | 2.3168E−08 |
| coefficient(J) | | | | | | | |
| 22nd order | −4.9437E−01 | 1.6871E−01 | −8.3000E−05 | −3.0000E−06 | −1.9276E−07 | 3.5364E−08 | −2.4305E−09 |
| coefficient(L) | | | | | | | |
| 24th order | 1.4362E−01 | −3.8424E−02 | 2.3000E−05 | 1.7467E−07 | 1.9842E−08 | −1.2655E−09 | 1.2629E−10 |
| coefficient(M) | | | | | | | |
| 26th order | −2.8001E−02 | 5.8669E−03 | −3.0000E−06 | −6.9170E−09 | −1.1683E−09 | 3.0109E−11 | −3.8077E−12 |
| coefficient(N) | | | | | | | |
| 28th order | 3.2924E−03 | −5.3740E−04 | 1.5446E−07 | 1.5442E−10 | 3.7999E−11 | −4.2784E−13 | 6.3623E−14 |
| coefficient(O) | | | | | | | |
| 30th order | −1.7676E−04 | 2.2000E−05 | −3.5670E−09 | −1.4431E−12 | −5.3181E−13 | 2.7472E−15 | −4.5786E−16 |
| coefficient(P) | | | | | | | |

Also, the optical imaging system configured as described above may have the aberration characteristics illustrated in FIG. 18.

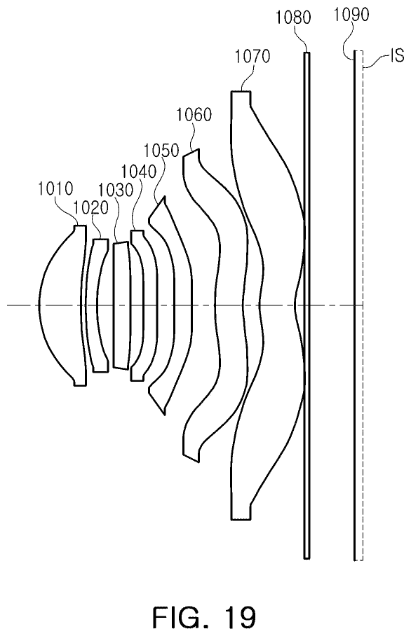

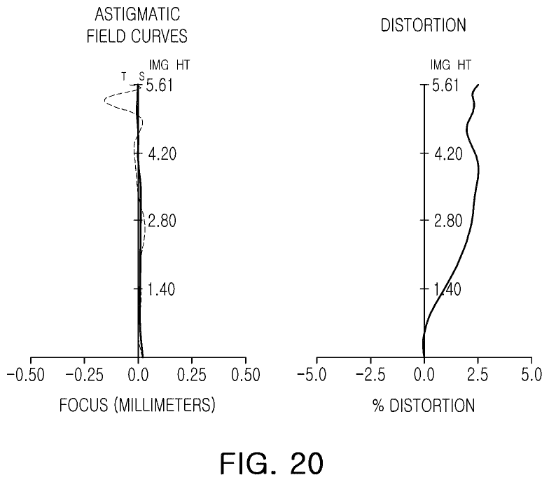

An optical imaging system according to a tenth embodiment will be described with reference to FIGS. 19 and 20.

The optical imaging system in tenth embodiment may include an optical system including a first lens 1010, a second lens 1020, a third lens 1030, a fourth lens 1040, a fifth lens 1050, a sixth lens 1060, and a seventh lens 1070, and may further include a filter 1080 and an image sensor IS.

The optical imaging system in the tenth embodiment may form a focus on the imaging plane 1090. The imaging plane 1090 may refer to a surface on which a focus may be formed by the optical imaging system. For example, the imaging plane 1090 may refer to one surface of the image sensor IS on which light is incident.

The lens characteristics of each lens (a radius of curvature, a thickness of the lens or a distance between the lenses, a refractive index, an Abbe number, and a focal length) are listed in Table 19.

TABLE 19

| Surface | | Radius of | Thickness or | Refractive | Abbe | Focal |
|---|---|---|---|---|---|---|
| No. | Elements | curvature | distance | index | number | length |
| S1 | First lens | 2.239 | 0.926 | 1.544 | 56.0 | 5.18 |
| S2 | | 9.137 | 0.100 | | | |
| S3 | Second lens | 7.556 | 0.250 | 1.680 | 18.2 | −15.53 |
| S4 | | 4.369 | 0.344 | | | |
| S5 | Third lens | 21.178 | 0.370 | 1.544 | 56.0 | 73.48 |
| S6 | | 44.550 | 0.284 | | | |
| S7 | Fourth lens | 69.977 | 0.289 | 1.671 | 19.2 | −59.36 |
| S8 | | 25.529 | 0.383 | | | |
| S9 | Fifth lens | 45.303 | 0.387 | 1.567 | 37.4 | 96.85 |
| S10 | | 250.296 | 0.504 | | | |
| S11 | Sixth lens | 4.084 | 0.618 | 1.544 | 56.0 | −202.85 |
| S12 | | 3.728 | 0.365 | | | |
| S13 | Seventh lens | 2.375 | 0.768 | 1.535 | 55.7 | −18.72 |
| S14 | | 1.704 | 0.206 | | | |
| S15 | Filter | Infinity | 0.110 | 1.517 | 64.2 | |
| S16 | | Infinity | 0.985 | | | |
| S17 | Imaging plane | Infinity | | | | |

The total focal length f of the optical imaging system in the tenth embodiment may be 6.11 mm, IMG HT may be 5.605 mm, FOV may be 83.8°, Fno may be 1.95, ET1 may be 0.255 mm, SWA71 may be 22.25°, and SWA72 may be 34.31°.

In the tenth embodiment, the first lens 1010 may have positive refractive power, the first surface of the first lens 1010 may be convex, and the second surface of the first lens 1010 may be concave.

The second lens 1020 may have negative refractive power, the first surface of the second lens 1020 may be convex, and a second surface of the second lens 1020 may be concave.

The third lens 1030 may have positive refractive power, the first surface of the third lens 1030 may be convex, and a second surface of the third lens 1030 may be concave.

The fourth lens 1040 may have negative refractive power, the first surface of the fourth lens 1040 may be convex, and the second surface of the fourth lens 1040 may be concave.

The fifth lens 1050 may have positive refractive power, the first surface of the fifth lens 1050 may be convex, and the second surface of the fifth lens 1050 may be concave.

The sixth lens 1060 may have negative refractive power, the first surface of the sixth lens 1060 may be convex in the paraxial region, and the second surface of the sixth lens 1060 may be concave in the paraxial region.

Also, at least one inflection point may be formed on at least one of the first and second surfaces of the sixth lens 1060. For example, the first surface of the sixth lens 1060 may be convex in the paraxial region and may be concave in a portion other than the paraxial region. The second surface of the sixth lens 1060 may be concave in the paraxial region and may be convex in a portion other than the paraxial region.

The seventh lens 1070 may have negative refractive power, the first surface of the seventh lens 1070 may be convex in the paraxial region, and the second surface of the seventh lens 1070 may be concave in the paraxial region.

Also, at least one inflection point may be formed on at least one of the first and second surfaces of the seventh lens 1070. For example, the first surface of the seventh lens 1070 may be convex in the paraxial region and may be concave in a portion other than the paraxial region. The second surface of the seventh lens 1070 may be concave in the paraxial region and may be convex in a portion other than the paraxial region.

Each surface of the first lens 1010 to the seventh lens 1070 may have an aspherical coefficient as in Table 20. For example, both the object-side surface and the image-side surface of the first lens 1010 to the seventh lens 1070 may be aspherical.

TABLE 20

| | S1 | S2 | S3 | S4 | S5 | S6 | S7 |
|---|---|---|---|---|---|---|---|
| Conic | −0.612 | −14.389 | 6.588 | 3.725 | 67.864 | −99.000 | −99.000 |
| constant (K) | | | | | | | |
| 4th order | 9.1000E−03 | −2.6943E−02 | −4.3352E−02 | −9.8012E−03 | −1.2081E−02 | −3.4081E−02 | −4.7656E−02 |
| coefficient(A) | | | | | | | |
| 6th order | −2.2802E−02 | 8.5005E−02 | 1.7267E−01 | −2.0002E−01 | −1.2841E−01 | 3.1825E−02 | −1.0368E−01 |
| coefficient(B) | | | | | | | |
| 8th order | 1.2893E−01 | −3.2838E−01 | −1.0599E+00 | 2.1619E+00 | 8.2367E−01 | −6.7757E−03 | 6.7138E−01 |
| coefficient(C) | | | | | | | |
| 10th order | −4.4196E−01 | 9.6428E−01 | 4.9311E+00 | −1.2349E+01 | −3.2469E+00 | −5.8585E−01 | −2.5136E+00 |
| coefficient(D) | | | | | | | |
| 12th order | 9.9192E−01 | −1.9446E+00 | −1.5217E+01 | 4.5710E+01 | 8.4729E+00 | 3.1210E+00 | 6.3273E+00 |
| coefficient(E) | | | | | | | |
| 14th order | −1.5139E+00 | 2.7436E+00 | 3.2142E+01 | −1.1615E+02 | −1.4927E+01 | −8.7847E+00 | −1.1445E+01 |
| coefficient(F) | | | | | | | |
| 16th order | 1.6157E+00 | −2.7727E+00 | −4.7840E+01 | 2.0892E+02 | 1.7577E+01 | 1.5918E+01 | 1.5279E+01 |
| coefficient(G) | | | | | | | |
| 18th order | −1.2258E+00 | 2.0350E+00 | 5.1015E+01 | −2.7020E+02 | −1.2942E+01 | −1.9781E+01 | −1.5214E+01 |
| coefficient(H) | | | | | | | |
| 20th order | 6.6444E−01 | −1.0879E+00 | −3.9150E+01 | 2.5214E+02 | 4.3826E+00 | 1.7254E+01 | 1.1298E+01 |
| coefficient(J) | | | | | | | |
| 22nd order | −2.5537E−01 | 4.1981E−01 | 2.1445E+01 | −1.6824E+02 | 1.4874E+00 | −1.0573E+01 | −6.1800E+00 |
| coefficient(L) | | | | | | | |
| 24th order | 6.7937E−02 | −1.1404E−01 | −8.1789E+00 | 7.8273E+01 | −2.4764E+00 | 4.4625E+00 | 2.4209E+00 |
| coefficient(M) | | | | | | | |
| 26th order | −1.1891E−02 | 2.0715E−02 | 2.0635E+00 | −2.4113E+01 | 1.2430E+00 | −1.2361E+00 | −6.4289E−01 |
| coefficient(N) | | | | | | | |
| 28th order | 1.2314E−03 | −2.2617E−03 | −3.0949E−01 | 4.4197E+00 | −3.0464E−01 | 2.0233E−01 | 1.0366E−01 |
| coefficient(O) | | | | | | | |
| 30th order | −5.7000E−05 | 1.1237E−04 | 2.0893E−02 | −3.6484E−01 | 3.0657E−02 | −1.4837E−02 | −7.6553E−03 |
| coefficient(P) | | | | | | | |
| | S8 | S9 | S10 | S11 | S12 | S13 | S14 |
| Conic | −99.000 | −60.371 | 99.000 | −15.255 | −79.798 | −18.094 | −6.487 |
| constant (K) | | | | | | | |
| 4th order | −5.6190E−02 | −9.0194E−02 | −8.2188E−02 | −1.3166E−02 | −1.9003E−03 | −1.2657E−01 | −6.8550E−02 |
| coefficient(A) | | | | | | | |
| 6th order | 1.8394E−03 | 1.4358E−01 | 2.7262E−02 | 2.4173E−04 | 6.0399E−03 | 6.1505E−02 | 3.1043E−02 |
| coefficient(B) | | | | | | | |
| 8th order | 7.9842E−02 | −4.7488E−01 | −1.8587E−02 | −4.6844E−03 | −1.1606E−02 | −3.0450E−02 | −1.2382E−02 |
| coefficient(C) | | | | | | | |
| 10th order | −2.6722E−01 | 1.1582E+00 | 1.7085E−02 | 2.8668E−04 | 6.9314E−03 | 1.2666E−02 | 3.6532E−03 |
| coefficient(D) | | | | | | | |
| 12th order | 5.1816E−01 | −1.9231E+00 | −2.4638E−03 | 2.2945E−03 | −2.2996E−03 | −3.6550E−03 | −7.4748E−04 |
| coefficient(E) | | | | | | | |
| 14th order | −7.2397E−01 | 2.2448E+00 | −1.2692E−02 | −1.7029E−03 | 4.4463E−04 | 7.2435E−04 | 1.0320E−04 |
| coefficient(F) | | | | | | | |
| 16th order | 7.6517E−01 | −1.8944E+00 | 1.4790E−02 | 6.1898E−04 | −3.8000E−05 | −1.0116E−04 | −9.0000E−06 |
| coefficient(G) | | | | | | | |
| 18th order | −6.1515E−01 | 1.1724E+00 | −8.4424E−03 | −1.3588E−04 | −4.0000E−06 | 1.0000E−05 | 4.5015E−07 |
| coefficient(H) | | | | | | | |
| 20th order | 3.7194E−01 | −5.3246E−01 | 2.9417E−03 | 1.9000E−05 | 2.0000E−06 | −1.0000E−06 | −1.3831E−09 |
| coefficient(J) | | | | | | | |
| 22nd order | −1.6553E−01 | 1.7531E−01 | −6.6329E−04 | −2.0000E−06 | −2.7493E−07 | 3.8360E−08 | −1.4071E−09 |
| coefficient(L) | | | | | | | |
| 24th order | 5.2392E−02 | −4.0658E−02 | 9.7000E−05 | 1.0808E−07 | 2.4407E−08 | −1.3995E−09 | 9.9272E−11 |
| coefficient(M) | | | | | | | |
| 26th order | −1.1135E−02 | 6.2869E−03 | −9.0000E−06 | −3.9707E−09 | −1.3202E−09 | 3.3957E−11 | −3.4144E−12 |
| coefficient(N) | | | | | | | |
| 28th order | 1.4230E−03 | −5.8057E−04 | 4.7122E−07 | 7.7312E−11 | 4.0469E−11 | −4.9221E−13 | 6.1726E−14 |
| coefficient(O) | | | | | | | |
| 30th order | −8.3000E−05 | 2.4000E−05 | −1.0711E−08 | −5.4094E−13 | −5.4077E−13 | 3.2246E−15 | −4.6953E−16 |
| coefficient(P) | | | | | | | |

Also, the optical imaging system configured as described above may have the aberration characteristics illustrated in FIG. 20.

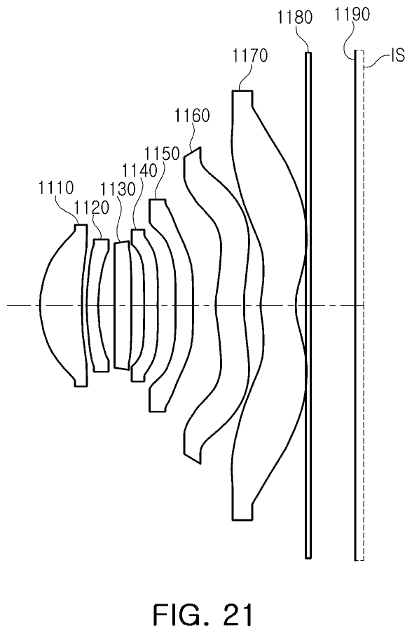

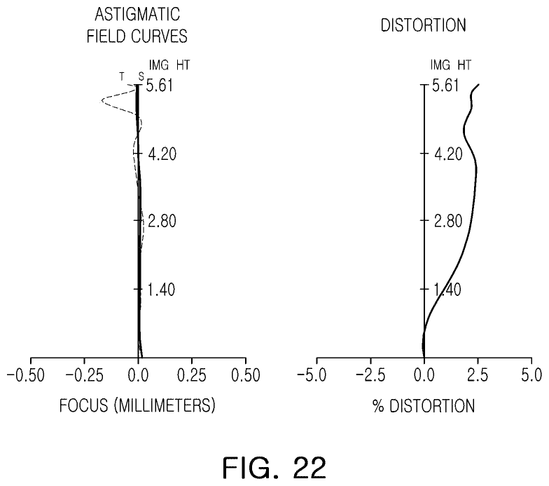

An optical imaging system according to an eleventh embodiment will be described with reference to FIGS. 21 and 22.

The optical imaging system in the eleventh embodiment may include an optical system including a first lens 1110, a second lens 1120, a third lens 1130, a fourth lens 1140, a fifth lens 1150, a sixth lens 1160, and a seventh lens 1170, and may further include a filter 1180 and an image sensor IS.

The optical imaging system in the eleventh embodiment may form a focus on the imaging plane 1190. The imaging plane 1190 may refer to a surface on which a focus may be formed by the optical imaging system. For example, the imaging plane 1190 may refer to one surface of the image sensor IS on which light is incident.

The lens characteristics of each lens (a radius of curvature, a thickness of the lens or a distance between the lenses, a refractive index, an Abbe number, and a focal length) are listed in Table 21.

TABLE 21

| Surface | | Radius of | Thickness or | Refractive | Abbe | Focal |
|---|---|---|---|---|---|---|
| No. | Elements | curvature | distance | index | number | length |
| S1 | First lens | 2.240 | 0.927 | 1.544 | 56.0 | 5.18 |
| S2 | | 9.197 | 0.100 | | | |
| S3 | Second lens | 7.617 | 0.250 | 1.680 | 18.2 | −15.43 |
| S4 | | 4.378 | 0.343 | | | |
| S5 | Third lens | 21.154 | 0.370 | 1.544 | 56.0 | 71.32 |
| S6 | | 45.993 | 0.284 | | | |
| S7 | Fourth lens | 74.223 | 0.289 | 1.671 | 19.2 | −57.64 |
| S8 | | 25.583 | 0.387 | | | |
| S9 | Fifth lens | 48.216 | 0.392 | 1.567 | 37.4 | 77.07 |
| S10 | | −500.000 | 0.505 | | | |
| S11 | Sixth lens | 4.121 | 0.617 | 1.544 | 56.0 | −194.38 |
| S12 | | 3.757 | 0.368 | | | |
| S13 | Seventh lens | 2.423 | 0.765 | 1.535 | 55.7 | −17.45 |
| S14 | | 1.713 | 0.206 | | | |
| S15 | Filter | Infinity | 0.110 | 1.517 | 64.2 | |
| S16 | | Infinity | 0.976 | | | |
| S17 | Imaging plane | Infinity | | | | |

The total focal length f of the optical imaging system in the eleventh embodiment may be 6.11 mm, IMG HT may be 5.605 mm, FOV may be 83.8°, Fno may be 1.95, ET1 may be 0.254 mm, SWA71 may be 22.33°, and SWA72 may be 33.93°.

In the eleventh embodiment, the first lens 1110 may have positive refractive power, the first surface of the first lens 1110 may be convex, and the second surface of the first lens 1110 may be concave.

The second lens 1120 may have negative refractive power, the first surface of the second lens 1120 may be convex, and a second surface of the second lens 1120 may be concave.

The third lens 1130 may have positive refractive power, the first surface of the third lens 1130 may be convex, and a second surface of the third lens 1030 may be concave.

The fourth lens 1140 may have negative refractive power, the first surface of the fourth lens 1140 may be convex, and the second surface of the fourth lens 1140 may be concave.

The fifth lens 1150 may have positive refractive power, the first and second surfaces of the fifth lens 1150 may be convex in the paraxial region.

The sixth lens 1160 may have negative refractive power, the first surface of the sixth lens 1160 may be convex in the paraxial region, and the second surface of the sixth lens 1160 may be concave in the paraxial region.

Also, at least one inflection point may be formed on at least one of the first and second surfaces of the sixth lens 1160. For example, the first surface of the sixth lens 1160 may be convex in the paraxial region and may be concave in a portion other than the paraxial region. The second surface of the sixth lens 1160 may be concave in the paraxial region and may be convex in a portion other than the paraxial region.

The seventh lens 1170 may have negative refractive power, the first surface of the seventh lens 1170 may be convex in the paraxial region, and the second surface of the seventh lens 1170 may be concave in the paraxial region.

Also, at least one inflection point may be formed on at least one of the first and second surfaces of the seventh lens 1170. For example, the first surface of the seventh lens 1170 may be convex in the paraxial region and may be concave in a portion other than the paraxial region. The second surface of the seventh lens 1170 may be concave in the paraxial region and may be convex in a portion other than the paraxial region.

Each surface of the first lens 1110 to the seventh lens 1170 may have an aspherical coefficient as in Table 22. For example, both the object-side surface and the image-side surface of the first lens 1110 to the seventh lens 1170 may be aspherical.

TABLE 22

| | S1 | S2 | S3 | S4 | S5 | S6 | S7 |
|---|---|---|---|---|---|---|---|
| Conic | −0.612 | −14.401 | 6.681 | 3.718 | 68.010 | −82.928 | −27.875 |
| constant (K) | | | | | | | |
| 4th order | 1.0173E−02 | −2.6771E−02 | −4.3447E−02 | −1.0370E−02 | −1.1060E−02 | −3.4405E−02 | −4.5993E−02 |
| coefficient(A) | | | | | | | |
| 6th order | −2.8655E−02 | 8.3215E−02 | 1.7568E−01 | −1.8337E−01 | −1.5123E−01 | 3.4906E−02 | −1.1559E−01 |
| coefficient(B) | | | | | | | |
| 8th order | 1.4646E−01 | −3.1864E−01 | −1.0917E+00 | 1.9747E+00 | 1.0488E+00 | −2.7866E−02 | 6.9008E−01 |
| coefficient(C) | | | | | | | |
| 10th order | −4.7416E−01 | 9.2592E−01 | 5.1041E+00 | −1.1214E+01 | −4.4604E+00 | −4.9153E−01 | −2.4146E+00 |
| coefficient(D) | | | | | | | |
| 12th order | 1.0292E+00 | −1.8366E+00 | −1.5785E+01 | 4.1441E+01 | 1.2508E+01 | 2.8513E+00 | 5.6975E+00 |
| coefficient(E) | | | | | | | |
| 14th order | −1.5391E+00 | 2.5325E+00 | 3.3380E+01 | −1.0540E+02 | −2.3744E+01 | −8.2574E+00 | −9.6749E+00 |
| coefficient(F) | | | | | | | |
| 16th order | 1.6207E+00 | −2.4849E+00 | −4.9727E+01 | 1.9003E+02 | 3.0666E+01 | 1.5166E+01 | 1.2148E+01 |
| coefficient(G) | | | | | | | |
| 18th order | −1.2180E+00 | 1.7580E+00 | 5.3080E+01 | −2.4649E+02 | −2.6313E+01 | −1.8965E+01 | −1.1414E+01 |
| coefficient(H) | | | | | | | |
| 20th order | 6.5539E−01 | −8.9863E−01 | −4.0783E+01 | 2.3077E+02 | 1.3719E+01 | 1.6571E+01 | 8.0388E+00 |
| coefficient(J) | | | | | | | |
| 22nd order | −2.5039E−01 | 3.2862E−01 | 2.2370E+01 | −1.5451E+02 | −2.8245E+00 | −1.0139E+01 | −4.2032E+00 |
| coefficient(L) | | | | | | | |
| 24th order | 6.6266E−02 | −8.3781E−02 | −8.5449E+00 | 7.2138E+01 | −1.2658E+00 | 4.2624E+00 | 1.5901E+00 |
| coefficient(M) | | | | | | | |
| 26th order | −1.1544E−02 | 1.4139E−02 | 2.1593E+00 | −2.2303E+01 | 1.0839E+00 | −1.1736E+00 | −4.1270E−01 |
| coefficient(N) | | | | | | | |
| 28th order | 1.1902E−03 | −1.4195E−03 | −3.2443E−01 | 4.1031E+00 | −3.0907E−01 | 1.9066E−01 | 6.5846E−02 |
| coefficient(O) | | | | | | | |
| 30th order | −5.5000E−05 | 6.4000E−05 | 2.1939E−02 | −3.3997E−01 | 3.3356E−02 | −1.3856E−02 | −4.8681E−03 |
| coefficient(P) | | | | | | | |
| | S8 | S9 | S10 | S11 | S12 | S13 | S14 |
| Conic | −88.968 | −68.885 | −99.000 | −15.311 | −78.983 | −18.227 | −6.491 |
| constant (K) | | | | | | | |
| 4th order | −5.1387E−02 | −9.1993E−02 | −7.9128E−02 | −1.3332E−02 | −1.9722E−03 | −1.2674E−01 | −6.8055E−02 |
| coefficient(A) | | | | | | | |
| 6th order | −4.7227E−02 | 1.5106E−01 | 1.6588E−02 | 3.7843E−04 | 6.4205E−03 | 6.1441E−02 | 3.0283E−02 |
| coefficient(B) | | | | | | | |
| 8th order | 3.2115E−01 | −4.9215E−01 | 1.1295E−02 | −5.1078E−03 | −1.2128E−02 | −3.0446E−02 | −1.1798E−02 |
| coefficient(C) | | | | | | | |
| 10th order | −1.0119E+00 | 1.1870E+00 | −3.5771E−02 | 9.3984E−04 | 7.3467E−03 | 1.2724E−02 | 3.3817E−03 |
| coefficient(D) | | | | | | | |
| 12th order | 2.0840E+00 | −1.9628E+00 | 5.8497E−02 | 1.7620E−03 | −2.5189E−03 | −3.6923E−03 | −6.6562E−04 |
| coefficient(E) | | | | | | | |
| 14th order | −3.0583E+00 | 2.2898E+00 | −6.0742E−02 | −1.4332E−03 | 5.2565E−04 | 7.3592E−04 | 8.7000E−05 |
| coefficient(F) | | | | | | | |
| 16th order | 3.2867E+00 | −1.9347E+00 | 4.1453E−02 | 5.2719E−04 | −5.9000E−05 | −1.0335E−04 | −7.0000E−06 |
| coefficient(G) | | | | | | | |
| 18th order | −2.6076E+00 | 1.1995E+00 | −1.9024E−02 | −1.1407E−04 | −7.7725E−08 | 1.0000E−05 | 2.1749E−07 |
| coefficient(H) | | | | | | | |
| 20th order | 1.5226E+00 | −5.4585E−01 | 5.9569E−03 | 1.6000E−05 | 1.0000E−06 | −1.0000E−06 | 1.5016E−08 |
| coefficient(J) | | | | | | | |
| 22nd order | −6.4531E−01 | 1.8006E−01 | −1.2751E−03 | −1.0000E−06 | −2.1571E−07 | 3.9819E−08 | −2.2227E−09 |
| coefficient(L) | | | | | | | |
| 24th order | 1.9287E−01 | −4.1830E−02 | 1.8357E−04 | 7.2533E−08 | 2.0215E−08 | −1.4597E−09 | 1.2725E−10 |
| coefficient(M) | | | | | | | |
| 26th order | −3.8513E−02 | 6.4781E−03 | −1.7000E−05 | −2.0660E−09 | −1.1235E−09 | 3.5580E−11 | −4.0440E−12 |
| coefficient(N) | | | | | | | |
| 28th order | 4.6097E−03 | −5.9906E−04 | 1.0000E−06 | 1.7124E−11 | 3.4979E−11 | −5.1797E−13 | 7.0096E−14 |
| coefficient(O) | | | | | | | |
| 30th order | −2.5011E−04 | 2.5000E−05 | −2.1697E−08 | 3.0903E−13 | −4.7186E−13 | 3.4072E−15 | −5.1932E−16 |
| coefficient(P) | | | | | | | |

Also, the optical imaging system configured as described above may have the aberration characteristics illustrated in FIG. 22.

TABLE 23

| Conditional Expression | Embodiment 1 | Embodiment 2 | Embodiment 3 | Embodiment 4 | Embodiment 5 | Embodiment 6 |
|---|---|---|---|---|---|---|
| f1/f | 0.893 | 0.918 | 0.887 | 0.854 | 0.867 | 0.853 |
| v1 − v2 | 36.75 | 37.84 | 36.75 | 36.75 | 36.75 | 36.75 |
| v1 − v4 | 36.75 | 37.84 | 36.75 | 36.75 | 36.75 | 36.75 |
| v1 − v6 | 18.59 | 18.59 | 18.59 | 18.59 | 18.59 | 18.59 |
| f2/f | −2.699 | −2.684 | −2.823 | −3.082 | −2.590 | −2.837 |
| f3/f/100 | 0.043 | 0.042 | 0.048 | 0.053 | 0.095 | −8.860 |
| f4/f/100 | −0.041 | −0.046 | −0.031 | −0.026 | 0.134 | −3.779 |
| f5/f/100 | −0.111 | −0.153 | 0.238 | 0.259 | −0.037 | −0.072 |
| f6/f | 1.461 | 1.263 | 1.596 | 1.553 | 1.533 | 1.481 |
| f7/f | −1.033 | −0.813 | −0.998 | −1.062 | −0.913 | −0.994 |
| TTL/f | 1.133 | 1.133 | 1.132 | 1.127 | 1.130 | 1.115 |
| f1/f2 | −0.331 | −0.342 | −0.314 | −0.277 | −0.335 | −0.301 |
| f1/f3 | 0.208 | 0.218 | 0.185 | 0.160 | 0.091 | −0.001 |
| BFL/f | 0.215 | 0.190 | 0.207 | 0.214 | 0.192 | 0.210 |
| D1/f | 0.017 | 0.026 | 0.016 | 0.016 | 0.016 | 0.016 |
| TTL/(2*IMG HT) | 0.615 | 0.615 | 0.615 | 0.615 | 0.615 | 0.615 |
| FOV*(IMG HT/f) | 77.253 | 77.078 | 77.126 | 76.874 | 76.825 | 75.287 |
| f/EPD | 1.950 | 1.795 | 1.946 | 1.945 | 1.950 | 1.951 |
| CT1/ET1 | 3.057 | 3.134 | 2.836 | 3.350 | 3.313 | 3.471 |
| \|f1/f2/n2\| | 0.198 | 0.203 | 0.188 | 0.166 | 0.200 | 0.180 |
| \|f1/f4/n4\| | 0.131 | 0.118 | 0.170 | 0.197 | 0.039 | 0.001 |
| SWA71 | 23.88 | 29.67 | 24.74 | 26.64 | 24.55 | 24.89 |
| SWA72 | 30 | 41.66 | 31.3 | 32.75 | 37.23 | 34.47 |
| n2 + n4 + n5 | 4.956 | 4.975 | 4.956 | 4.956 | 4.956 | 4.956 |

| Conditional Expression | Embodiment 7 | Embodiment 8 | Embodiment 9 | Embodiment 10 | Embodiment 11 |
|---|---|---|---|---|---|
| f1/f | 0.830 | 0.843 | 0.851 | 0.848 | 0.848 |
| v1 − v2 | 36.75 | 37.84 | 37.84 | 37.84 | 37.84 |
| v1 − v4 | 36.75 | 36.75 | 36.75 | 36.75 | 36.75 |
| v1 − v6 | 18.59 | 18.59 | 0 | 0 | 0 |
| f2/1 | −2.480 | −2.588 | −2.546 | −2.542 | −2.525 |
| f3/f/100 | −0.852 | 0.670 | 0.117 | 0.120 | 0.117 |
| f4/f/100 | −0.325 | −0.131 | −0.096 | −0.097 | −0.094 |
| f5/f/100 | −0.127 | −0.173 | 0.212 | 0.159 | 0.126 |
| f6/f | 1.575 | 1.609 | 8.175 | −33.200 | −31.813 |
| f7/f | −1.005 | −1.008 | −1.900 | −3.064 | −2.856 |
| TTL/f | 1.118 | 1.118 | 1.129 | 1.127 | 1.127 |
| f1/f2 | −0.335 | −0.326 | −0.334 | −0.334 | −0.336 |
| f1/f3 | −0.010 | 0.013 | 0.073 | 0.070 | 0.073 |
| BFL/f | 0.203 | 0.197 | 0.203 | 0.213 | 0.211 |
| D1/f | 0.016 | 0.016 | 0.016 | 0.016 | 0.016 |
| TTL/(2*IMG HT) | 0.616 | 0.615 | 0.615 | 0.615 | 0.615 |
| FOV*(IMG HT/f) | 75.400 | 75.604 | 77.000 | 76.874 | 76.874 |
| f/EPD | 1.951 | 1.951 | 1.951 | 1.950 | 1.950 |
| CT1/ET1 | 3.514 | 3.513 | 3.592 | 3.631 | 3.648 |
| \|f1/f2/n2\| | 0.200 | 0.194 | 0.199 | 0.198 | 0.200 |
| \|f1/f4/n4\| | 0.015 | 0.038 | 0.053 | 0.052 | 0.054 |
| SWA71 | 25.02 | 24.99 | 23 | 22.25 | 22.33 |
| SWA72 | 34.02 | 32.8 | 30.68 | 34.31 | 33.93 |
| n2 + n4 + n5 | 4.956 | 4.966 | 4.918 | 4.918 | 4.918 |

According to the aforementioned embodiments, the optical imaging system may have a reduced size while implementing high resolution.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens having positive refractive power, a convex object-side surface and a concave image-side surface;
a second lens having negative refractive power, a convex object-side surface and a concave image-side surface;
a third lens having positive refractive power;
a fourth lens having negative refractive power;
a fifth lens having refractive power;
a sixth lens having refractive power and a convex object-side surface; and
a seventh lens having negative refractive power, a convex object-side surface and a concave image-side surface,
wherein the first to seventh lenses are disposed in order from an object side of the optical imaging system toward an imaging plane of the optical imaging system,
wherein the optical imaging system has a total of seven lenses, and
wherein
0<f1/f<1.5,
−5<f2/f<−1,
−10<f3/f/100<2,
−5<f4/f/100<1,
−0.5<f1/f2<0,
−1<f1/f3<3,
70°<FOV×(IMG HT/f), and

|f1/f4/n4|<0.3
are satisfied,
where f is a total focal length of the optical imaging system, f1 is a focal length of the first lens, f2 is a focal length of the second lens, f3 is a focal length of the third lens, f4 is a focal length of the fourth lens, FOV is a field of view of the optical imaging system, IMG HT is half a diagonal length of the imaging plane, and n4 is a refractive index of the fourth lens.

2. The optical imaging system of claim 1,
wherein
25<v1−v2<45 and
25<v1−v4<45
is satisfied,
where v1 is an Abbe number of the first lens, v2 is an Abbe number of the second lens, and v4 is an Abbe number of the fourth lens.

3. The optical imaging system of claim 2,
wherein
v2+v4<v1, and
v2+v4<v3
are satisfied,
where v3 is an Abbe number of the third lens.

4. The optical imaging system of claim 1, wherein |f1/f2/n2|<0.3 is satisfied, where n2 is a refractive index of the second lens.

5. The optical imaging system of claim 1, wherein −3<f5/f/100<3 is satisfied, where f5 is a focal length of the fifth lens.

6. The optical imaging system of claim 1, wherein −50<f6/f<10 is satisfied, where f6 is a focal length of the sixth lens.

7. The optical imaging system of claim 1, wherein −5<f7/f<0 is satisfied, where f7 is a focal length of the seventh lens.

8. The optical imaging system of claim 1, wherein D1/f<0.1 is satisfied, where D1 is a distance on an optical axis between the image-side surface of the first lens and the object-side surface of the second lens.

9. The optical imaging system of claim 8,
wherein
TTL/f<1.3 and
BFL/f<0.3
are satisfied,
where BFL is a distance on an optical axis from the image-side surface of the seventh lens to the imaging plane, and TTL is a distance on the optical axis from the object-side surface of the first lens to the imaging plane.

10. The optical imaging system of claim 1, wherein 1.5<f/EPD<2.3 is satisfied, where EPD is an incident pupil diameter of the optical imaging system.

11. The optical imaging system of claim 1, wherein 2<CT1/ET1<5 is satisfied, where CT1 is a thickness of the first lens on an optical axis, and ET1 is a thickness of the first lens at an end of an effective diameter.

12. The optical imaging system of claim 1, wherein
wherein at least one of
SWA71<30° and
SWA72<42°
are satisfied,
where SWA71 is a sweep angle of the seventh lens on an end of an effective diameter of the object-side surface of the seventh lens, and SWA72 is a sweep angle of the seventh lens on an end of an effective diameter of the image-side surface of the seventh lens.

13. The optical imaging system of claim 1, wherein the first to seventh lenses are formed of a plastic material, and an object-side surface and an image-side surface of each of the first to seventh lenses are aspherical.

14. The optical imaging system of claim 13, wherein the sixth lens has at least one inflection point formed on at least one of the object-side surface and an image-side surface.

15. The optical imaging system of claim 13, wherein the seventh lens has at least one inflection point formed on at least one of the object-side surface and the image-side surface.

16. The optical imaging system of claim 1, wherein the third lens has a convex object-side surface.

17. The optical imaging system of claim 16, wherein the fourth lens has a concave object-side surface and a concave image-side surface.

18. The optical imaging system of claim 1, wherein the fifth lens has a convex image-side surface.

19. The optical imaging system of claim 1, wherein the sixth lens has a concave image-side surface.

20. The optical imaging system of claim 1, wherein the fifth lens has positive refractive power, and the sixth lens has negative refractive power.
